(19) United States
(12) Patent Application Publication
(10) Pub. No.: US 2012/0159306 A1
(43) Pub. Date: Jun. 21, 2012

(54) System And Method For Processing XML Documents

(75) Inventors: Rakesh Sharma, Redwood City, CA (US); Yulia Groza, San Francisco, CA (US)

(73) Assignee: WAL-MART STORES, INC., Bentonville, AR (US)

(21) Appl. No.: 12/969,573

(22) Filed: Dec. 15, 2010

(51) Int. Cl. G06F 17/00

(52) U.S. Cl. 715/234

(57) ABSTRACT

An improved system and method for processing XML documents combines a pull-based streaming parser such as StAX with an XML object binding framework such as XMLBeans. In this manner, XML documents of arbitrary size can be processed without being subject to memory limitations.

In addition, various embodiments of the present invention provide a framework that insulates application code from StAX and XMLBeans. Application data objects need not be aware of StAX and XMLBeans. Code can thereby be more easily maintained, and can be swapped, enhanced, or otherwise modified without adversely impacting the operation of applications.

### FIELD OF THE INVENTION

The present invention relates to systems and methods for processing Extended Markup Language (XML) documents, and more particularly to a framework for enabling generation, parsing and processing of such documents of arbitrary size without regard to memory limitations.

### DESCRIPTION OF THE RELATED ART

XML (Extensible Markup Language) is a widely-used set of rules for encoding documents electronically. Many programming interfaces are available for accessing XML data, and many XML-based formats exist for software development and use. Although an XML specification exists, it is often necessary to convert XML documents from one format to another so that they can be understood by different software applications. Such conversion may be needed, for example, when integrating disparate systems having different versions of the XML specification.

XML parsers process XML documents in a variety of ways. Generally, such parsers employ an application programming interface (API) to access the XML.

Existing APIs for XML processing tend to fall into one of the following categories:
Serial (or stream-oriented) APIs (e.g., Simple API for XML (SAX)
Tree-traversal APIs accessible from a programming language, such as Document Object Model (DOM)
XML data binding, which provides an automated translation between an XML document and programming-language objects
Declarative transformation languages such as XSLT and XQuery

In serial APIs such as SAX, data is processed in a serial manner using an event-driven push model. No in-memory representation of the XML document is constructed. The XML document is traversed linearly, with only a portion being loaded into memory at any given time. As the parser encounters XML statements, it generates events that are captured by the software application. Thus, the parser does not have access to the entire XML document simultaneously.

Applications using such serial APIs define a number of callback methods which are called by the parser when events are fired during parsing of an XML document.

By avoiding the need to hold the entire XML document in memory at any given time, serial APIs allow processing of arbitrarily large XML documents while maintaining a relatively economical memory footprint. The memory footprint of a serial API is based on the maximum depth of the XML file (the maximum depth of the XML tree) and the maximum data stored in XML attributes on a single XML element, which are often smaller than the memory required to hold the entire XML document.

However, for certain types of data transformations, the serial approach may not be effective, particularly if such transformations require the entire XML document to be available simultaneously (in other words, the parser cannot perform the transformation in a serial manner). In addition, the parser generally cannot maintain parent/child relationships among XML document elements. Applications using serial APIs need to provide handlers (callbacks) to handle all fired events. Serial APIs thus place a greater burden on the application to maintain such parent/child relationships, and to perform transformations that require the entire XML document to be available. This greater burden on applications makes serial APIs limited in their usefulness.

Tree-traversal and data-binding APIs may avoid such problems. For example, a Document Object Model (DOM) represents XML as a tree hierarchy of node objects and provides a standardized set of interfaces to access nodes and the underlying hierarchy. XML parsing can be performed by traversing the tree. Although the interfaces provide by DOM can be easier to use, they generally require that the entire tree remain in memory. An in-memory tree needs much larger space than the XML document it represents, and therefore may not be practical for very large XML documents.

Similarly, XML object binding tools such as XMLBeans, Castor, and Java Architecture for XML Binding (JAXB) keep the entire object model representing the XML document in memory.

For example, XMLBeans is a Java-to-XML binding framework that allows Java developers to access and process XML data without having to know XML or XML processing. XMLBeans simplifies access to an XML document from a Java application by presenting the XML document to the application in the form of Java objects. Conversely, it provides the necessary tools to convert these Java objects back into an XML document.

XMLBeans has full XML schema support and provides schema mapping to equivalent Java classes and typing constructs as naturally as possible. XMLBeans uses XML Schema to compile Java interfaces and classes that can be used to access and modify XML instance data.

XMLBeans therefore provides a Java object-based view of XML data that preserves the original native XML structure. It also preserves XML document integrity. The entire XML instance document is handled as a whole. The XML data is stored in memory as XML. This means that the document order is preserved as well as the original element content with white space.

XMLBeans can be a very useful tool for XML programming situations in which the document is available in-memory. However, such an in-memory model suffers the same limitations as described above for a DOM or other tree-traversal technique: the application may run out-of-memory while processing large XML documents.

Accordingly, in any of the above-described tree-traversal or data-binding approaches, the size of the XML document that can be processed is limited by the amount of memory available. In addition, in such implementations, the application code is often necessarily peppered with the XML object binding tool code. The lack of separation between business logic and XML tool codes can make it difficult and/or confusing to use or maintain such a system.

Declarative transformation languages such as XSLT (XSL Transformations) and XQuery are also capable of XML document transformation. However, such languages are limited in capability. For example, in such systems, the XML document usually is represented by the DOM and therefore inherits the limitations of the DOM. Furthermore, there is no object representation of the XML data; XSLT is only used for transforming data from one format to another.

Another approach uses Streaming API for XML (StAX). StAX operates as a compromise between the event-based and tree-based models offered, respectively, by serial APIs and DOMs. In the StAX metaphor, the programmatic entry point is a cursor that represents a point within the document. The application drives the parser, essentially moving the cursor through the document so as to pull information as it needs it. This is in contrast to an event-based API (such as SAX) which pushes data to the application, requiring the application to maintain state between events as necessary to keep track of location within the document.

Like SAX, StAX can process arbitrarily large sizes of XML documents, yet control still remains with the application rather than the parser. The application tells the parser to get next chunk of data when it wants to receive rather than the parser telling the application when the next chunk of data is ready. Furthermore, StAX is capable of reading existing XML documents and can also create new XML documents without any size limits. SAX is a unidirectional parser and can not be used for generating new XML documents, whereas StAX is a bidirectional API.

StAX thus works well for processing large documents one section at a time, essentially moving from the beginning of the document to the end in a sequential manner. However, StAX is not a good solution when the application needs to access widely separated parts of the document concurrently and in potentially unpredictable sequence.

What is needed, therefore, is a XML processing system and method that provides the advantages of a serial API while permitting random access to different portions of the document and without requiring the application to be involved with low-level details of parsing. What is further needed is a technique that is not subject to stringent memory limitations as are found in the above-described tree-traversal methods such as DOM. What is further needed is an XML parsing scheme that avoids the limitations and disadvantages of prior art methods.

### SUMMARY OF THE INVENTION

In various embodiments, the present invention provides an improved system and method for processing XML documents by combining a pull-based streaming parser such as StAX with an XML object binding framework such as XMLBeans. In this manner, the present invention is able to process XML documents of arbitrary size without being subject to memory limitations.

In addition, various embodiments of the present invention provide a framework that insulates application code from StAX and XMLBeans. Application data objects need not be aware of StAX and XMLBeans. Code can thereby be more easily maintained; the use of XML parser (StAX) together with XML object binding framework (XMLBeans) allows code to be swapped, enhanced, or otherwise modified without adversely impacting the operation of applications.

In various embodiments, the system and method of the present invention also provide the following features and advantages:
Configurable schema validation and delegation of handling of validation error messages to application so that they can be handled by application-specific handlers
Configurable skipping/inclusion of segments which fail XML Schema Definition (XSD) validation
Configurable customization of XSD error messages to help identify records that fail XSD validation
Configurable transformations of XML files into flat files via XPaths
Incremental generation of XML from application data objects
Serial extraction and processing of XML segments while providing corresponding application data objects

The combination of a pull-based streaming parser such as StAX with an XML object binding framework such as XMLBeans allows the XML parser of the present invention to operate on XML documents of any size, while facilitating schema mapping to equivalent Java interfaces/classes so that programmers can deal with Java objects rather than low level XML processing. An XML document can thereby be processed in segments as needed by the application. One segment is extracted at a time from the XML document; XMLBeans is used to load the extracted segment into objects. Conversely, an XML document can be created by generating XML segments from XMLBeans objects, and using StAX to stream the generated XML. In this manner, an XML document of any size can be incrementally generated.

In one embodiment, application data objects are insulated from StAX and XMLBeans code by providing a separate translation layer to provide mapping between XMLBeans objects and application data objects. XMLBeans-related code therefore does not proliferate into other parts of the application as it will be contained only within the translation layer. Accordingly, developers familiar with XMLBeans can concentrate on the translation layer, while application developers can concentrate on implementation of business logic part without ever needing to understand StAX or XMLBeans.

### BRIEF DESCRIPTION OF THE DRAWINGS

The accompanying drawings illustrate several embodiments of the invention and, together with the description, serve to explain the principles of the invention. One skilled in the art will recognize that the particular embodiments illustrated in the drawings are merely exemplary, and are not intended to limit the scope of the present invention.

FIG. 1 is a block diagram depicting an example of an architecture for practicing the invention according to one embodiment.

FIG. 2A is an event trace diagram depicting a method for processing an XML document according to one embodiment.

FIGS. 2B and 2C are an event trace diagram depicting a method for processing an XML document according to another embodiment.

FIGS. 3A and 3B are event trace diagrams depicting a method for generating an XML document according to one embodiment.

FIGS. 4A and 4B are event trace diagrams depicting a method for converting an XML document to a flat file according to one embodiment.

FIG. 5 is a flow diagram depicting an overview of a method for processing an XML document according to one embodiment.

FIG. 6 is a flow diagram depicting an overview of a method for generating an XML document according to one embodiment.

FIG. 7 is a class diagram for a producer class according to one embodiment.

FIG. 8 is a class diagram for a consumer class according to one embodiment.

### DETAILED DESCRIPTION OF THE EMBODIMENTS

### System Architecture

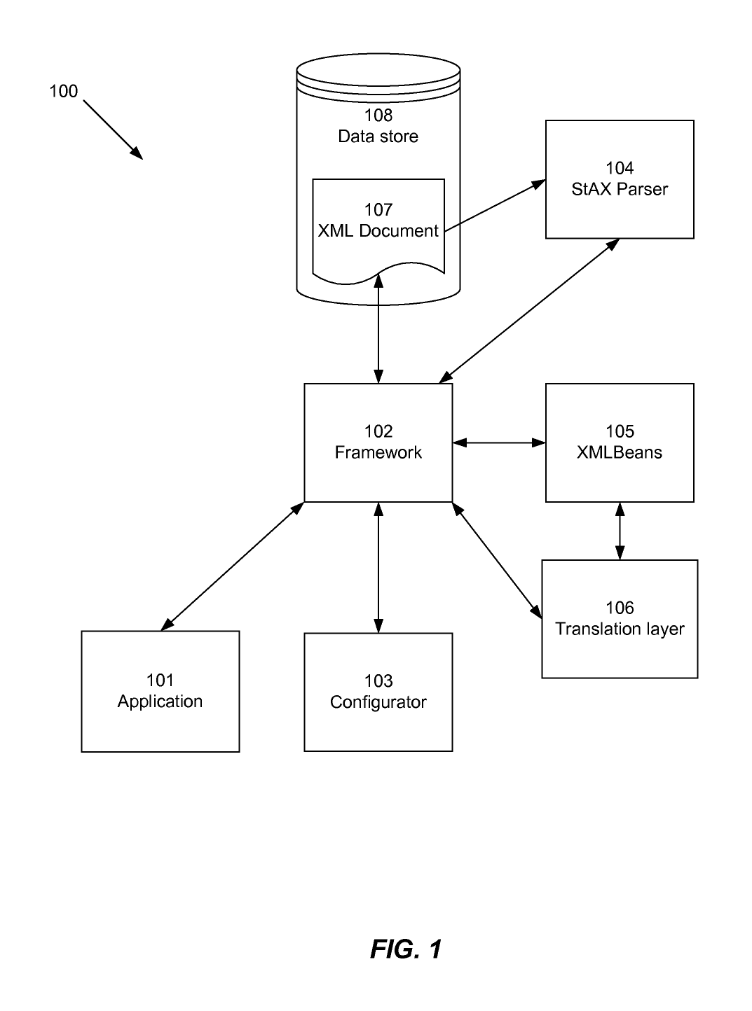

Referring now to FIG. 1, there is shown a block diagram depicting an example of an architecture for practicing the invention according to one embodiment. XML parsing system 100 includes framework 102, configurator 103, StAX parser 104, XMLBeans 105, and translation layer 106. XML document 107 can come from any source, such as for example a data store 108 that may be local or remote with respect to the other components of the present invention. Application 101 is any software application that requires data from XML document 107. Framework 102 is a functional module for controlling the generation of XML documents 107 as well as the extraction and parsing of data from an existing XML document 107. Framework employs and interacts with other components in order to implement the techniques of the present invention, including StAX parser 104 for streamed parsing of XML document 107 and XMLBeans 105 for implementing an object binding framework that insulates application code from raw XML. Translation layer 106 generates domain objects from XMLBeans objects so as to provide mapping between XMLBeans objects and application data objects. Configurator 103 provides information to framework 103 as to the structure of the XML, translator class, inclusion/exclusion of invalid records, whether perform XSD validation, XML to flat file transformation configuration etc.

The various functional modules shown in FIG. 1 can be implemented as software running on separate computing entities or they may be combined in any desired configuration. They may be implemented in a distributed manner across any number of hardware devices. Communication among the functional modules may take place over any known digital communications medium, and using known network protocols such as TCP/IP and HTTP. The particular arrangement of functional modules in FIG. 1 and otherwise described herein is intended to be illustrative of one embodiment of the present invention, and should not be considered to limit the scope of the invention in any manner.

According to the techniques of the present invention, XML parsing system 100 facilitates processing of XML documents of arbitrary size, without being subject to memory limitations, and wherein application data objects are insulated from StAX and XMLBeans code by providing a separate translation layer 106 to provide mapping between XMLBeans objects and application data objects.

In one embodiment, system 100 provides a mechanism by which application 101 can be in control, so that application 101 requests data from framework 102 when needed, in a pull-based paradigm. In addition, in one embodiment, system 100 employs an object binding framework (such as XMLBeans 105) to allow system 100 to operate on XML documents of any size, while facilitating schema mapping to equivalent Java interfaces/classes so that programmers can deal with Java objects rather than low-level XML processing.

In one embodiment, in response to a request from application 101, framework 102 extracts a portion of XML document 107 as needed to satisfy the request. The extracted XML portion is passed to XMLBeans 105, which generates an in-memory model of that portion and returns it to the framework 102 for presentation to application 101. In this manner, the need for representing the entire XML document 107 in memory is avoided.

In one embodiment, translation layer 106 translates the in-memory model generated by XMLBeans 105 so that it is in the form of domain objects understandable by application 101. For example, if an application requests an employee object including a first name, last name, address, and the like, but the XML representing that data has a different format, translation layer 106 performs the translation needed.

### Method of Operation

According to the techniques of the present invention, at least three types of operations are available: processing an XML document to obtain application data objects corresponding to XML segments and sub-segments; generating an XML document from application data, and converting an XML document into a flat file.

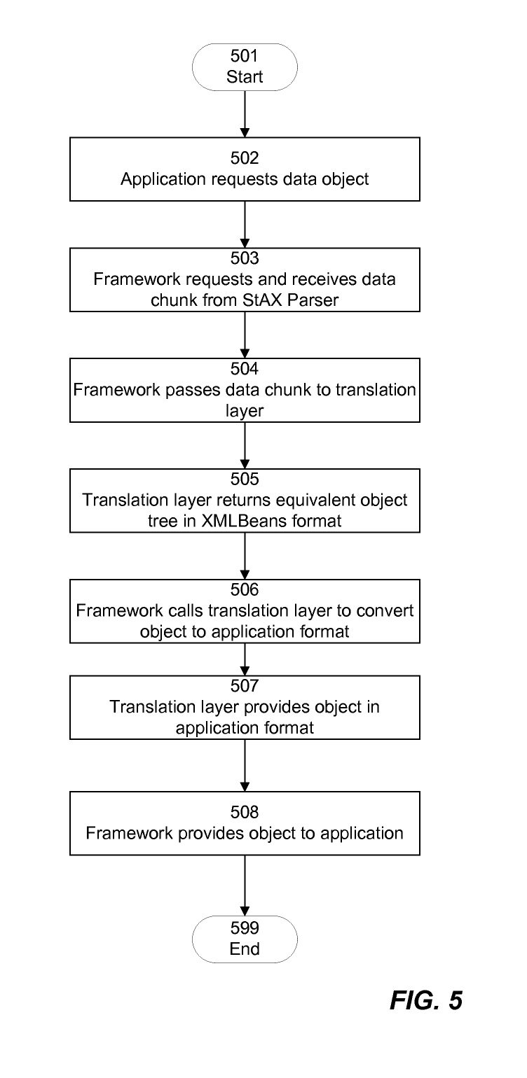

Referring now to FIG. 5, there is shown a flow diagram depicting an overview of a method for processing an XML document according to one embodiment. Application 101 requests 502 a data object. Framework 102 requests 503 and receives a data chunk from StAX parser 104. For example, if application 101 has requested data representing an employee, the data chunk from StAX parser 104 might be the next chunk of data representing an employee. Framework 102 then passes 504 the data chunk to translation layer 106, which performs a conversion and returns 505 the equivalent object tree in XMLBeans format. Once framework 102 receives the object tree, it calls 506 translation layer 106 to convert the object to a format which application 101 can understand. Translation layer 106 translates the object tree to such a format, so that the result is free of XML low-level APIs, XMLBeans objects, and other artifacts the application is not concerned with.

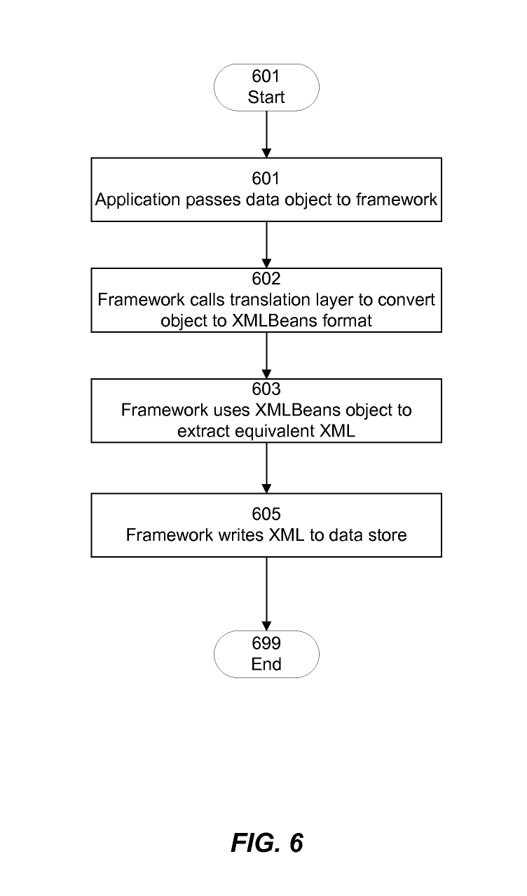

Referring now to FIG. 6, there is shown a flow diagram depicting an overview of a method for generating an XML document according to one embodiment. Application 101 passes a data object to framework 102. Framework 102 calls translation layer 106 to perform the translation to an XMLBeans object. Once the translation has taken place, framework 102 uses 603 the XMLBeans object to extract equivalent XML. Framework 102 then writes 605 the XML to data store 108. In one embodiment, step 605 involves starting creation of a new XML document, or appending the XML to an existing XML document that was previously started. In this manner, piecemeal, or streaming, creation of XML documents is facilitated.

In one embodiment, framework 102 does the writing of the XML as soon as a specified memory limit is reached. StAX parser 104 is used to determine what portion of the XML should be written and what portion should be kept in memory to be written when all sub-segments are written. For example, suppose the following XML is to be generated:

```
<employees>
      <employee>...... . . </employee>
      <employee>...... . . </employee>
      <employee>...... . . </employee>
      ....................................... . .
</employees>
```

This is accomplished by generating each “employee” segment incrementally within the “employees” segment. In one embodiment, the following steps are performed in order to generate the XML:
1) First generate the “employees” segment, but do not write its end tag (</employees>). Hold the generated segment in memory. Framework 102 passes the XML to StAX parser 104 and asks it to break the XML into individual tags such as opening and ending tags. Framework 102 then writes all tags other than the ending one. Here, framework 102 is making use of StAX parser 104 to identify the individual tags within the XML segment.
2) Continue adding “employee” elements. Framework 102 continues appending XML corresponding to the employee data.
3) Write end tag </employees> once application 101 indicates that all employee” elements have been added.

In one embodiment, the system of the present invention is also able to perform document conversions of various types. For example, it is sometimes useful to convert XML documents to flat files; such conversion may be used for bulk uploading of data files when operating in connection with components (such as SQL*Loader) that may not be capable of uploading XML. When performing document conversion, it may sometimes be necessary to obtain data from different parts of the original XML document when generating the flat file. Each data chunk generally corresponds to a line (or number of lines) in the resultant flat file. However, data for populating the line may come from another chunk, for example one that may need to be obtained from a different source (or combination of sources). In one embodiment, configurator 103 interprets an initial data chunk that identifies senders of other data chunks, so that those pieces of data that are needed for generating a line of the flat file can be retrieved and held in memory for as long as needed to generate the line of the flat file. Data elements that are cross-referenced by the data chunk being processed can thereby be retrieved as needed. In this manner, configurator 103 ensures that the necessary data elements are retrieved and present, while still keeping memory usage to a manageable amount. In one embodiment, the line in the flat file specifies the source of the data.

For example, suppose a partner's (i.e. an auxiliary source of data) information is needed for obtaining relevant information in generating the flat file. The first data chunk from the XML document might specify the partner. The identification of the partner is relevant to obtaining additional information for processing of other data chunks. Thus, framework maintains the partner name in memory while processing other data chunks, so as to facilitate generation of the flat file. Configurator 103 provides framework 102 with the information needed to determine which data elements should be maintained in memory and which can be discarded once they have been processed.

In one embodiment, configurator 103 specifies such information using an XPath document. The XPath document indicates which data items are cross-references and further indicates which data chunks require which data to be present. XPath, the XML Path Language, is a well known query language for selecting nodes from an XML document. Given this information, framework 102 is able to hold cross-references in memory for as long as needed and to discard those items that are no longer needed. The XPath document may vary from one XML type to another.

In one embodiment, once cross-references are no longer needed, they may be discarded even if the document conversion is not yet complete, for example if there is a need to free up memory. In another embodiment, cross-references are retained until the document conversion is completed. In yet another embodiment, cross-references that are no longer needed are swapped out to disk or other storage, so that they may be made available later.

### Processing an XML Document

In one embodiment, the system of the present invention can process an XML document 107 to generate application domain objects usable by application 101 in performing some operation (such as servicing a client request). XML documents 107 can contain many different types of information, including for example “to” and “from” tags indicating where the document should go and where it comes from. An example of an XML document containing employee information is as follows:

```
<wmi>
      <header>
            <to ... .  />
            <from .../>
      </header>
      <employees>
            <employee>
            ...
            <employee>
            ...
            ...
      </employees>
</wmi>
```

In one embodiment, application domain objects are generated based on keys passed by application 100 (such as the <employee> keys shown in the above example). Keys can be mapped to corresponding XML segments via a configuration file used by configurator 103.

StAX parser 104 extracts the segment corresponding to each segment name passed in by application 101. XMLBeans 105 generates the corresponding XMLBeans object using the extracted XML segment. Framework 102 performs XSD validation on the generated XMLBeans object; validation errors are delegated to an application-specific error handler for further processing.

In one embodiment, in case of XSD validation failure, the next segment with the same key is fetched by framework 102 (unless framework 102 is configured to include invalid XML segments). This process is repeated until a valid segment is found, or the beginning of next segment is detected, or the entire XML document 107 is exhausted.

In one embodiment, framework 102 delegates the creation of application data objects from XMLBeans objects to translation layer 106. The resulting application data object is returned to application 101.

In one embodiment, the system of the present invention is able to process XML documents 107 of arbitrary size without encountering memory limitations. Application 101 is able to obtain application data objects corresponding to data contained in a segment without the inclusion of any of its sub-segments, so that application 101 can then obtain data for each sub-segment in an incremental, serial fashion. In one embodiment, this is accomplished by calling an openSegment( ) method, which returns an instance of SegmentCursor class. Application 101 can obtain a data object corresponding to a particular segment, without the inclusion of any data from its sub-segments, by using the method getDataObject( ). The method next( ) can be used recursively to obtain data objects corresponding to employee sub-segments serially.

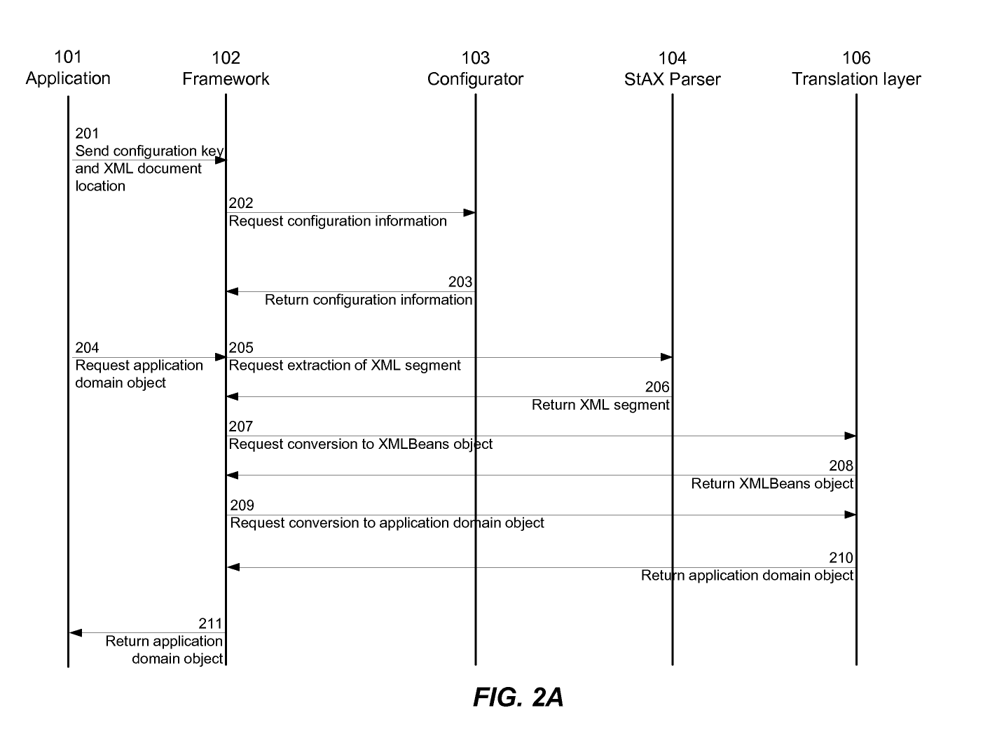

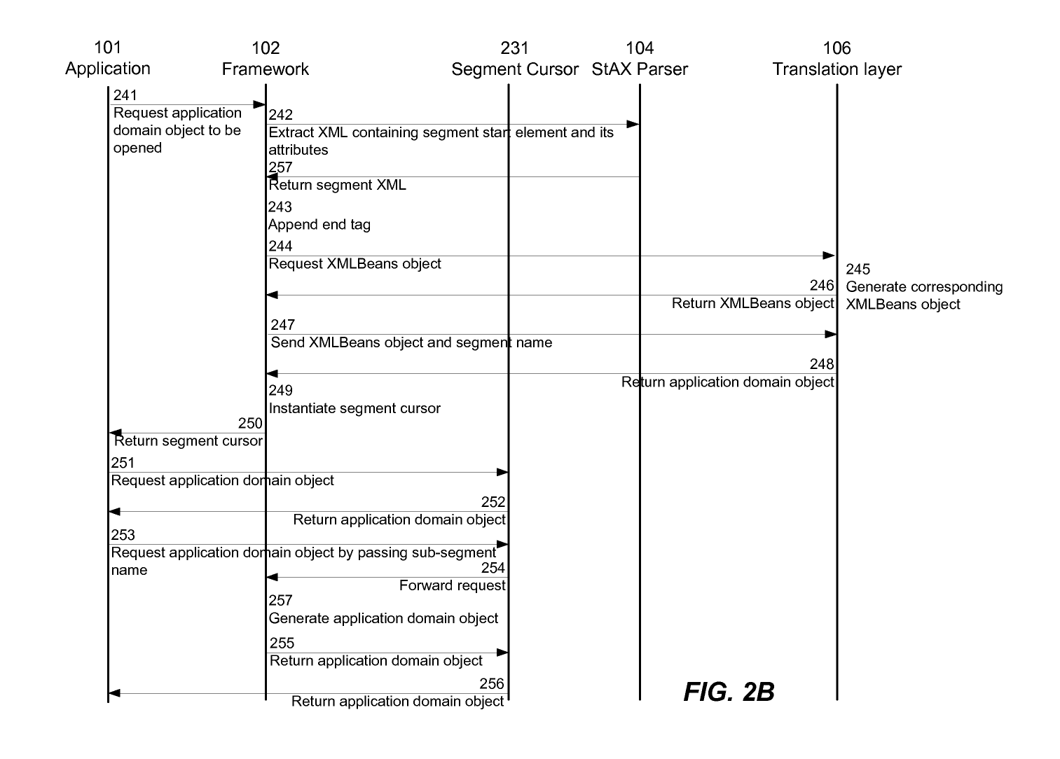

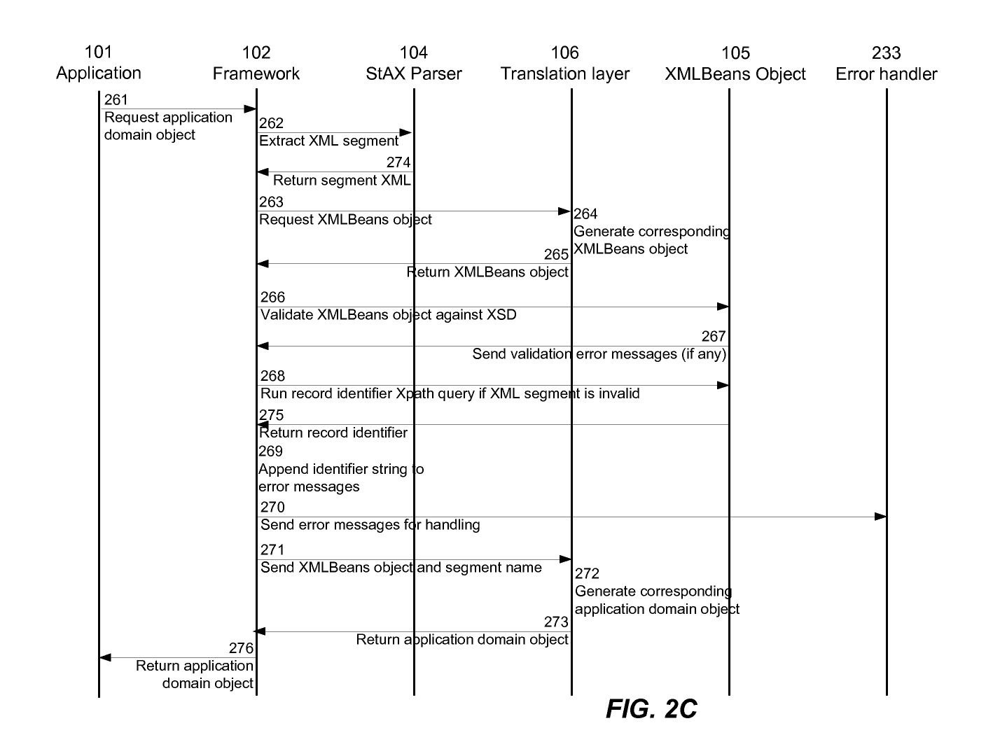

Referring now to FIG. 2A, there is shown an event trace diagram depicting processing an XML document according to one embodiment. The particular steps depicted in FIG. 2A are merely exemplary of one embodiment of the present invention. Application 101 sends the location of the XML document and the configuration key to framework 102. Framework requests 202 configuration information (such as the structure of the XML document) from configurator 103, based on the key provided by application 101.

In order to retrieve this information, framework 102 requests, from configurator 103, the location of the XML segment “header” containing the “to” and “from” information, as shown in the above example XML document. Configurator 103 contains a mapping indicating where relevant portions of XML document 107 can be found; accordingly, configurator 103 responds to request 202 by sending 203 configuration information about the XML structure, including, for example, segments, sub-segments, X-Path queries, translator classes, and the like. In the example above, such information is found in the header of XML document 107.

Application 101 requests the application domain object by providing the name of the XML segment. Framework 102 sends 205 a request to StAX parser 104 to extract the XML segment. StAX parser 104 parses XML document 107 until the identified information is encountered; in the above example, it parses XML document 107 until the “<header>” tag is found, and informs framework 102 when the tag is found. Framework continues retrieval of XML via StAX until end tag “</header>” is found.

In one embodiment, such parsing may involve repeated retrievals of data from data store 108. Once the identified information is encountered, StAX parser 104 returns 206 the XML segment.

Framework 102 then sends 207 a request to translation layer 106 to request conversion to an XMLBeans object, for example by passing the extracted XML segment and the segment name provided by the application. In one embodiment, translation layer 106 includes XMLBeans module 105 for converting the XML segment to XMLBeans objects according to well known techniques. Translation layer 106 and/or XMLBeans module 105 may be located locally or remotely with respect to framework 102 and with respect to other components of system 100. Translation layer 106 returns 208 the corresponding XMLBeans object generated using the XML segment and the segment name.

Framework 102 then sends 209 the XMLBeans object to translation layer 106 for conversion to an object in a format that is understandable by application 101, passing translation layer 106 the XMLBeans object and segment key. Once translation layer 106 has generated this application domain object, it returns 210 the application domain object, which framework 102 then returns 211 to application 101 for further processing.

In one embodiment, configurator 103 controls exception handling. For example, if invalid XML is encountered, configurator 103 can indicate whether the invalid XML should be skipped, or whether an attempt should be made to retrieve whatever portion of the invalid XML is retrievable.

Referring now to FIGS. 2B and 2C, there is shown an event trace diagram depicting processing an XML document according to another embodiment, including additional details and error handling.

Application 101 requests 241 that an application domain object for a segment be opened, for example by providing the name of the XML segment by issuing an openDataObject(segmentName) call. Framework 102 receives the call, and submits a request to StAX parser 104 to extract 242 a start element and attributes for the segment, for example by calling extractStartElementAndItsAttributes(segmentName). StAX parser 104 returns 257 the segment XML. Framework 102 then appends 243 an end tag to the extracted XML, for example by calling appendEndTagInExtractedXml( ). The extracted XML segment turns into a well-formed XML after the end tag is appended.

Framework 102 requests 244 an XMLBeans object from translation layer 106, for example by passing the extracted XML and segment name to translation layer 106 via a getXmlObject(extractedXml, segmentName) call. Translation layer 106 generates 245 a corresponding XMLBeans object by calling createCorrespondingXmlObject( ), and returns 246 the generated XMLBeans object. Framework 102 requests 247 an application domain object, for example by calling a generateDataObject(xmlObject) method. Translation layer 106 responds by returning 248 an application domain object.

Framework 102 then instantiates 249 a segment cursor encapsulating the application domain object, to keep track of a location within a segment, for example by calling an instantiateSegmentCursor(Object) method. This segment cursor is returned 250 to application 101. Application 101 can now request data objects in a pull-type arrangement, so that application 101 is in control of the data flow.

Application 101 requests 251 an application domain object encapsulated by segment cursor 231, for example by calling getDataObject( ). Segment cursor 231 returns 252 the requested application domain object. As needed, application 101 then requests 253 an application domain object by passing a sub-segment name, for example by issuing a next(subSegmentName) call. Segment cursor 231 forwards 254 the request to framework 102 providing the name of the current open segment and its sub-segment. Framework 102 generates 257 an application domain object, following techniques described above in connection with FIG. 2A. However, in one embodiment, XML is extracted only from within the current opened segment. Framework 102 then returns 255 the application domain object, and segment cursor 231 returns 256 the object to application 101.

Continuing with FIG. 2C, application 101 requests 261 an application domain object for the XML segment, for example by providing the name of the XML segment via a getDataObject(segmentName) call. Framework 102 calls 262 StAX parser 104 to extracts an XML segment for the identified segment name, for example by calling extractXmlSegment(segmentName). StAX parser 104 returns 274 the segment XML. Framework 102 then requests 263 an XMLBeans object, for example by passing the extracted XML and segment name via a getXmlObject(extractedXml,segmentName) call to translation layer 106. Translation layer 106 generates 264 an XMLBeans object corresponding to the extracted XML, for example by calling createCorrespondingXmlObject( ). Translation layer 106 returns 265 the XMLBeans object to framework 102.

In one embodiment, framework 102 validates 266 the XMLBeans object against the XSD, for example by calling validateAgainstXsd( ). The method call asks XMLBeans object to validate itself against the XSD. If any validation errors exist, framework 102 obtains 267 them from XMLBeans 105. Framework 102 runs 268 a record identifier XPath query (configured via Configurator) to extract record identifiers for those objects that have errors (runXPathQueriesToExtractRecordIdentifiers(xmlObject)); XMLBeans 105 returns 275 record identifier(s). Framework 102 appends 269 an identifier string to the error messages so that the source of the error can be identified (appendIdentifierStringToErrorMessages( )). Framework 102 then sends 270 each error message to error handler 233, including identification of the error and the object that caused it, for handling at error handler 233 (handleValidationErrors(code,message)).

Framework 102 then transmits 271 the XMLBeans object and segment name to translation layer 106 for conversion to an application domain object, for example by issuing a generateDataObject(xmlObject) call. Translation layer 106 performs the translation by generating 272 an application domain object corresponding to the XMLBeans object, and returns 273 the application domain object to framework 102 which then forwards 276 the application domain object to application 101.

### Generating an XML Document

As described herein, generation of XML document 107 can take place in piecemeal fashion, with application 101 providing information for each segment in turn, and indicating whether the segment is a full segment or an enclosing segment. Certain segments may be kept in memory while XML document 107 is being generated, while other segments may be too large to keep in memory, so that individual elements (such as records) may be generated and appended one by one.

Application 101 may need to generate an XML document 107 based on data from any number of data sources as well as application business logic. Application 101 therefore has the data encapsulated into application data objects; as described herein, these application data objects are used to produce an XML segment. The system of the present invention allows such a transformation to take place without requiring the application 101 to have any knowledge or awareness of StAX parser 104 or XMLBeans 105. Data objects are passed incrementally to framework 102, so that corresponding XML segments can be generated and appended to XML document 107 being generated.

Framework 102 starts producing XML code in its memory buffer, based on the data objects provided by application 101. The process continues, with buffered data being written to data store 108 when the memory buffer is full.

As described above, translation layer 106 provides the mapping between application data objects and corresponding XMLBeans objects. Framework 102 delegates the task of generating the XMLBeans objects to translation layer 106. Framework 102 performs validation on the XMLBeans objects generated by translation layer 106 against the XML Schema Definition (XSD) and delegates the handling of validation error messages to an application error handler. Framework 102 uses the XMLBeans object to generate a corresponding XML segment, and writes the segment into its buffer. In one embodiment, this buffer may be backed up to a more persistent data storage device. Once application 101 indicates the end of the XML generation process, the buffer is flushed and the file is closed.

In many situations, a large number of records are to be written. Since segment XML and corresponding XMLBeans objects are generated in memory, there may be resource limitations if framework 102 were to attempt to hold all the records in memory at the same time. Accordingly, the techniques of the present invention provide a mechanism by which elements in a segment can be added incrementally. Application 101 asks framework 102 to add a segment whose child segments (sub-segments) are to be added incrementally. Framework 102 removes the segment end tag (for example, </employees>) from the generated XML and pushes it into a stack. Application 101 can then continue adding employee sub-segments incrementally. Once application 101 has finished adding all sub-segments, the last tag from the stack is popped and appended back into the generated XML code. This incremental generation of XML allows for XML documents of arbitrary size to be generated without encountering memory limitations.

Sub-segments can be nested in one another as desired. Framework 102 does not impose any restrictions on the depth of the hierarchy. In one embodiment, it is the responsibility of application 101 to inform framework 102 when to open a segment and when to close it.

For example, in generating the XML code shown above, <header> segment is generated, along with <employees> segment and associated data, and enclosing <wmi> tag. In order to generate and write the <header> segment, the system opens the enclosing <wmi> tag and writes the <header> segment. The ending </wmi> tag may not yet be written because additional data (the <employees> segment) still needs to be written first. Accordingly, XML document 107 will temporarily be non-well-formed, since it will be missing the ending </wmi> tag. This ending tag can be held so that it can be written at the appropriate time.

In one embodiment if application 101 is attempting to write a segment of XML document 107 without writing entire document 107, it can pass an openSegment( ) call, so as to inform framework 102 that the segment should be opened but not yet closed, and that only a portion of the data is being sent, with more to follow later. This permits incremental writing of data elements (such as records). The ending tag may be obtained from StAX parser 104 and held in memory so that it can be written after the data elements have all been written.

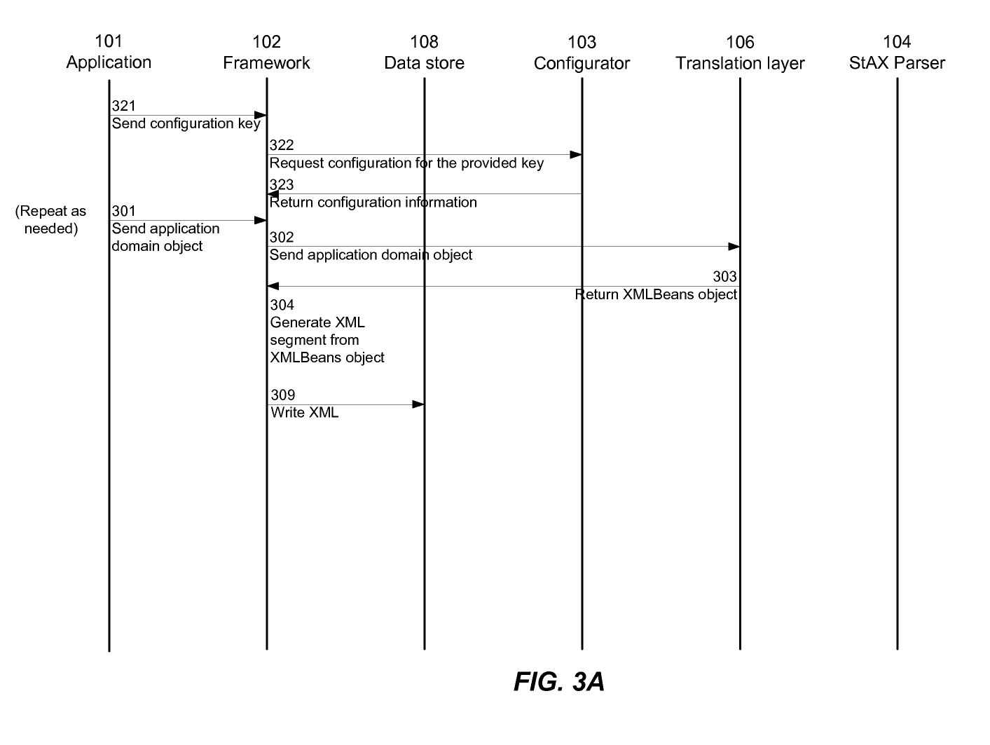

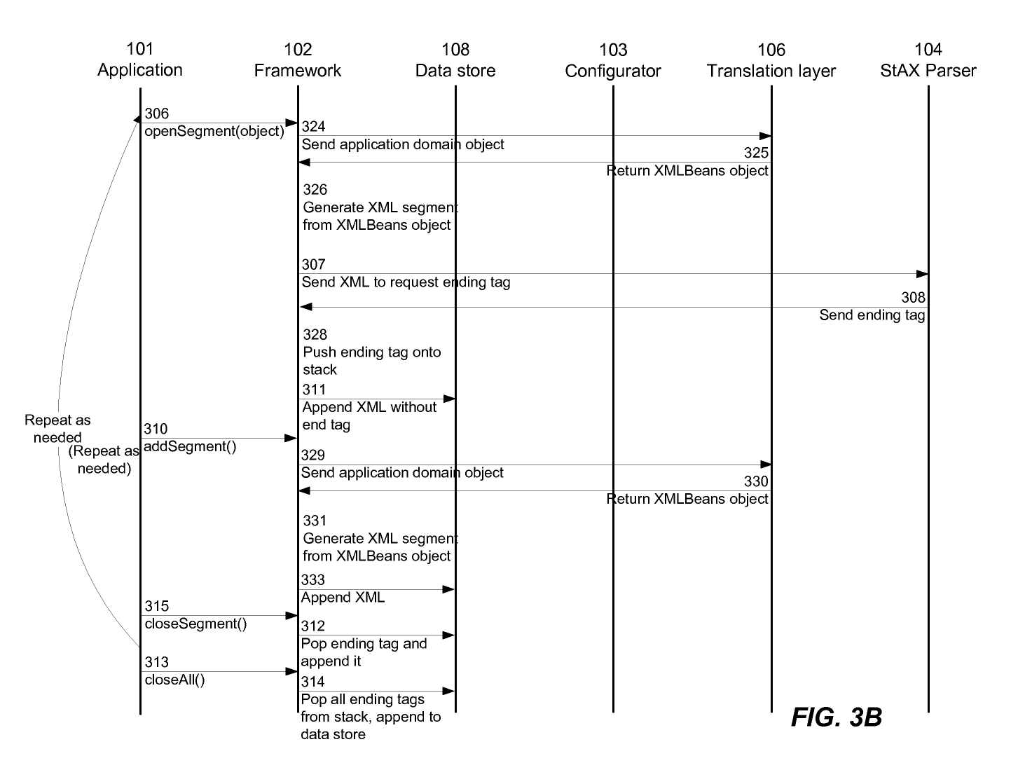

Referring now to FIGS. 3A and 3B, there is shown an event trace diagram depicting generating XML document 107 according to one embodiment. Application 101 sends 321 a configuration key to framework 102, which requests 322, from configurator 103, the configuration for the provided key. Configurator 103 returns 323 the requested configuration information, including data about the translator class, whether to ignore or include invalid XML segments, and the like.

Application 101 passes 301 an application domain object to framework 102, requesting that the object be converted to XML. Framework 102 sends 302 the object to translation layer 106, for example by issuing a generateXmlObject( ) call. Translation later 106 runs a method such as createCorrespondingXmlObject( ) and returns 303 a corresponding XMLBeans object. Framework 102 then generates 304 an XML segment from the XMLBeans object, for example using XMLObject classes generated using XSD. Framework 102 writes 309 the XML to data store 108, as follows.

Referring now to FIG. 3B, application 101 sends 306 an openSegment(object) call to framework 102. This call tells framework 102 to open a new segment for data to be written, but to not write an ending tag. Framework 102 sends 324 the application domain object to translation layer 106, for example by issuing a generateXmlObject( ) call. Translation later 106 returns 325 a corresponding XMLBeans object. Framework 102 then generates 326 a corresponding XML segment from the XMLBeans object, for example using XMLObject classes generated using XSDs.

Framework 102 sends 307 the XML to StAX parser 104 for parsing, so as to obtain the ending tag. StAX parser 104 parses the XML to identify the ending tag, and sends 308 the ending tag to framework 102. In one embodiment, step 307 is implemented using a removeSegmentEndTagAndPushItInStack( ) call, which causes the ending tag to be removed. Framework 102 holds the ending tag in an in-memory FIFO stack for later use, for example by saving the end tag in a stack. In some cases, multiple ending tags may be saved in this manner. The XML code, without the end tag, is appended 311 to data in data store 108. Using this technique, framework 102 is able to write the XML code in piece-meal fashion, allowing XML code of any arbitrary length to be written without running up against memory limitations. In one embodiment, this is implemented using a writeXmlToBufferBackedByFile( ) call, which causes the XML code to be written to a buffer which is also backed up to persistent storage.

For each segment to be added, application 101 sends 310 an addSegment( ) call to framework 102. It allows addition of arbitrary number of sub-segments to the currently opened segment. Framework 102 sends 329 the application domain object to translation layer 106, for example by issuing a generateXmlObject( ) call, which invokes a createCorrespondingXmlObject( ) method and returns 330 a corresponding XMLBeans object.

Optionally, framework 102 may validate the returned XMLBeans object against the XSD. If any error messages are returned, framework 102 requests record identifiers form translation layer 106, for example by issuing a getRecordIdentifiers( ) call. Translation layer 106 returns an identifier string extracted from the application data object. Translation layer 106 is responsible for extracting and generating a meaningful record identifier. Framework 102 appends the identifier string to error messages so that the appropriate records that caused the error can be identified; such an operation can be performed, for example, by an appendIdentifierStringToErrorMessages( ) call. If needed, an error handler can be invoked via a handleValidationErrors( ) call.

Framework 102 generates 331 the corresponding XML segment using XMLBeans object 330, for example using XMLObject classes generated using XSDs.

Framework 102 appends 333 the XML segment according to the instructions received from application 101.

Steps 310 and 329 through 333 are repeated for every segment being added.

Once all the data has been added to XML document 107, framework 102 is ready to close the enclosing open segment (if any exist) and append any other ending tags as needed to properly finish writing the document. Application 101 sends 315 a closeSegment( ) call, which causes framework 102 to pop 312 the ending tag from the in-memory stack for the segment whose sub-segments were being written incrementally, and to append the ending tag to the data being written at data store 108. In one embodiment, step 312 may be performed by calling a popStackAndWritePoppedEndTagToBufferBackedByFile( ) method.

Application 101 then sends 313 a closeAll( ) call, which causes framework 102 to retrieve all remaining closing tags from the stack and append them to XML document 107. For example, if the tags were saved in a stack, framework 102 pops 314 the tags from the stack and appends them to the data being written at data store 108. In this manner, the tags are written in the proper order. The result is a well-formed XML document 107 at data store 108. In one embodiment, steps 313 and 314 may be performed by calling a popStackUntilEmptyAndWritePoppedEndTagsToBufferBackedByFile( ) method, followed by a flushBuffer( ) method and a closeFile( ) method.

### Converting an XML Document to a Flat File

As mentioned above, in one embodiment, the system of the present invention is also able to perform document conversions of various types. For example, it is sometimes useful to convert XML documents to flat files. Flat files are data files that contain records with no structured relationships. They may be used, for example, for bulk uploading of data files when operating in connection with components (such as SQL*Loader) that may not be capable of uploading XML. Bulk loaders usually take input from a flat file and use some additional knowledge to interpret them. For example, Oracle SQL*Loader uses control files to provide additional information about file format properties.

In general, a flat file can take any form. One typical arrangement for a flat file includes the following sections:
Header data: Includes, for example, metadata including sender identifier, transaction identifier, date received, and the like. Generally includes information that does not need to be repeated in every body record.
Body data: Include individual records, such as employee records.
Footer data. Holds items for summarizing the data in the file, such as total number of records and the like.

In one embodiment, the system of the present invention provides a mechanism for transforming XML documents 107 into flat files. A configuration file, referred to as StaxBeanMapping.properties, provides information as to where various data items should be placed in the flat file. In this manner, data to be populated in the header, body, and/or footer sections can be specified, for example via the XPath query language. XPath can refer to XML objects corresponding to segments, sub-segments, and/or open segments. In this manner, memory usage is optimized, since only the corresponding segment of XML and/or the XMLBeans object need to be in memory at any given time. There is no need to hold the entire XML document in memory. If there is a need to cross-reference data from one segment to another, framework 102 provides for configuration of such cross-references, specified as XPath references, so that the appropriate data can be held in memory during the transformation.

Any type of field delimiters and record delimiters can be used to separate fields from one another and to separate records from one another. For example, tabs or commas can be used as field delimiters, and line breaks (carriage returns) can be used as record delimiters, so that each line of the flat file corresponds to a record.

In one embodiment, the flat file is defined by a configuration that specifies the syntax for the file. For example, the configuration may specify the order in which body data should appear, and any additional metadata that should be included (such as the total number of records, for example).

An example of an XML document 107 that can be converted to a flat file according to the techniques described herein is as follows:

```
<wmi>
      <header>
      </header>
      <employees>
            <employee>
            <employee>
            ...
      </employees>
      <departments>
            <department>
            <department>
            ...
      </departments>
</wmi>
```

It may be useful, in some situations, to enrich the flat file with application-specific data that was not part of the XML document 107. In one embodiment, framework 102 provides support for adding such data in the transformed flat file. Such data may be specified by the configuration, and may include, for example, data that can be extracted, derived, or calculated from the XML. Such data can include, for example:
Data items from the segment currently being processed: these may be specified, for example, using a segment XPath.
Data items that may be needed but not available from the segment currently being processed; these may be specified, for example, using a cross-reference XPath.
   In one embodiment, the XPath cross-reference type is specified in the configuration file indicating the framework that value represented by the XPath query should be saved in the memory and should be assigned an alias. The data corresponding to the XPath can be accessed subsequently by referring the corresponding alias. For example, the value of XPath query header/@senderID (extracted from header segment) can be assigned a cross-reference alias “senderID” which can be used by other segments to include the value corresponding to the XPath header/@senderID. In one embodiment, all cross referenced aliases are saved in memory as soon as segment to which they belong is processed.
   In one embodiment, the cross-reference data may include global data based on some formula that is accumulated over time and may represent a combination of data for several segments.
   In one embodiment, the cross-reference data may include record-by-record data that is maintained for some period of time and then disposed of when used.
Derived data items: these may include anything that is derived from one or more segments. An example is a record count, which keeps track of how many records have been processed. For example, framework 102 can keep a count of employee records (sub-segments) in each open segment while extracting each employee record and writing it into the flat file. The count can be written as part of employee record in the file. Also, it can be written in a footer section of the file.
Session data items: these may include any data that application 101 wishes to append, but that is not available in the XML. For example, if a partner source supplies an inventory file, the file name can be passed to the system and a file identifier can be returned. This file identifier may not be derivable from the XML, but it may be a useful piece of data to be added to the flat file. Accordingly, such data can be included in this category. Other examples include registration ID, time processed, and the like.
Application Data: Application 101 can add any number of name-value pairs during runtime. These values can be referenced by their names and can be added into any section(s) of the transformed file as desired.

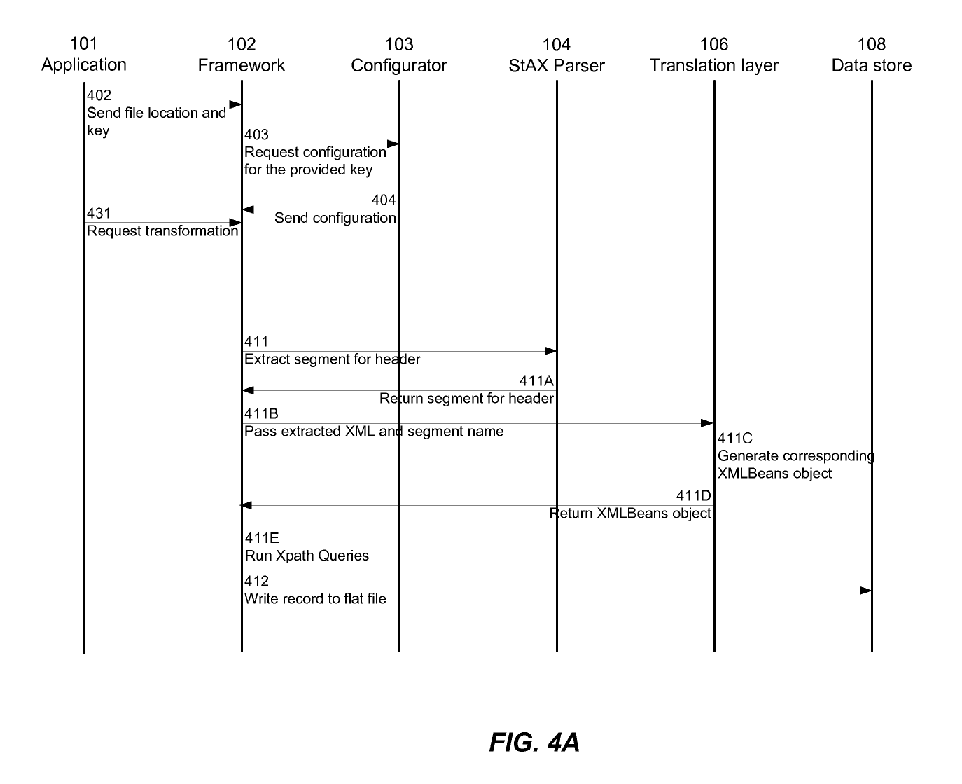

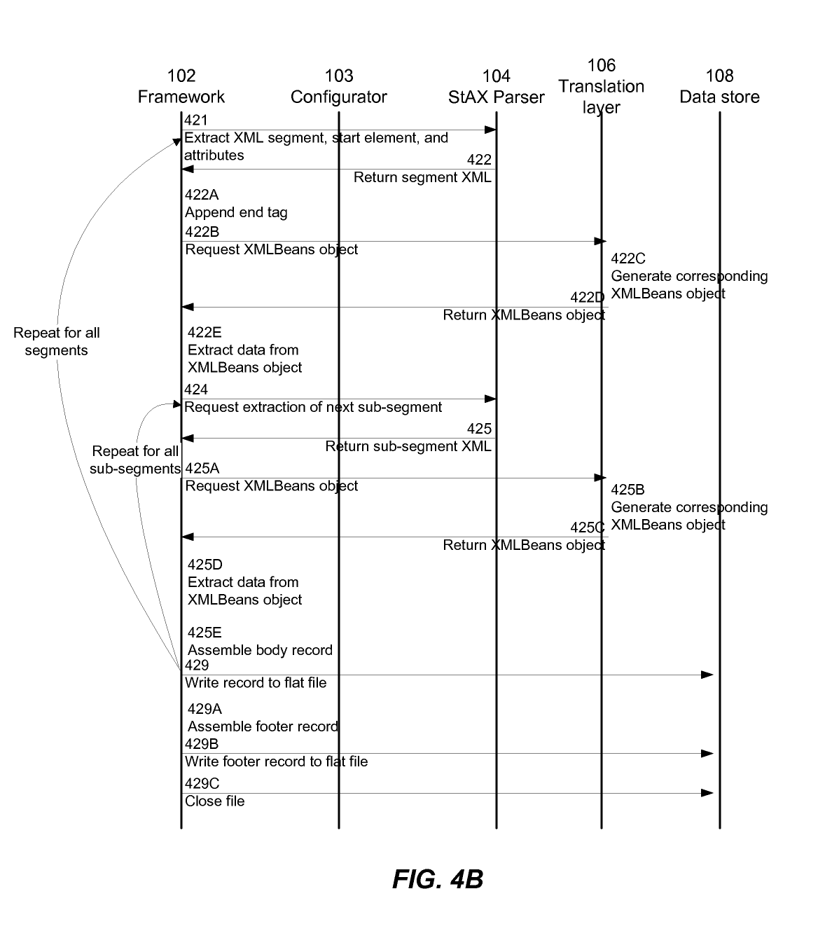

Referring now to FIGS. 4A and 4B, there is shown an event trace diagram depicting a method for converting an XML document 107 to a flat file according to one embodiment.

Application 101 calls framework 102 to initiate the XML-to-flat file conversion, sending 402 framework 102 the file location and the configuration key. In one embodiment, this is accomplished by application 101 sending a createInstance(String key, File inputFile) call to framework 102.

Framework 102 requests 403, from configurator 103, the configuration associated with the key. In response, configurator 103 sends 404 the configuration to framework 102. Having received the configuration, framework 102 now knows what elements of the XML file to use for the various parts of the flat file, including header, body, footer, delimiters, and the like.

The key sent by application 101 thus identifies a configuration that is, in one embodiment, unique to the type of XML being processed. The information contained in the configuration file and identified via key contains information such as:
Translator class;
Structure of XML such as segments and sub-segments;
Whether to skip or include invalid records; and
Whether to perform XSD validation.

In one embodiment, the configuration specifies the structure of the flat file, including information such as the order in which body data should appear, and any additional metadata that should be included. In one embodiment, the configuration can be specified as a Java class, although any desired format can be used.

Application 101 then requests 431 that a transformation be performed on the specified XML document.

Framework 102 calls StAX parser 104, providing it with the file location so that StAX parser 104 can begin parsing the file to extract the segment XML. Framework 102 requests specific data from StAX parser 104, such as the XML segment for the header and/or other XML segments. In response, StAX parser 104 parses the relevant portion of XML document 107 to obtain the XML segments, and returns this XML to framework 102. For example, for the header segment, framework 102 can perform these steps by calling extractXmlSegment(headerSegment).

In one embodiment, a header record for the flat file is generated by extracting the corresponding segment, configured in the configuration file, from the XML data. Any configured global cross references aliases are also extracted if found in the segment.

Framework 102 calls 411 StAX parser 104 to extract the segment needed to generate the header record of the flat file. Framework 102 gets the name of the segment from configurator 103 and passes it to StAX parser 104 to get the corresponding XML segment. StAX parser 104 returns 411A the requested XML segment for the header record.

Framework 102 passes 411B the extracted XML segment and segment name to translation layer 106. Translation layer generates 411C a corresponding XMLBeans object and returns it 411D to framework 102.

Framework 102 runs 411E the configured XPath queries on the XMLBeans object. It also runs XPath queries for configured cross-referenced aliases and stores them in memory for later use.

Framework 102 assembles the header record and writes it 412 to the flat file being generated at data store 108.

Any global data, cross-reference data, or the like can be stored (for example in an alias) so that it can be made available for use with other records.

Framework 102 processes segments whose sub-segments represent a record in the body of the transformed flat file. FIG. 4B depicts additional detail regarding the specific steps involved in writing the flat file. According to the method shown in FIG. 4B, framework 102 is able to maintain data in memory when such data may be needed for writing records to the flat file.

Framework 102 asks StAX parser 104 to provide the XML segment corresponding to each segment name. In one embodiment, framework 102 gets only the XML segment representing the start element and associated attributes. Thus, framework 102 requests 421 an XML segment, start element, and its attributes from StAX parser 104, configured for the body of the flat file to be written. StAX parser 104 returns 422 the requested XML. Framework 102 appends 422A an end tag to the extracted XML, to generate a well-formed XML.

Framework 102 then loops through a process of extraction of segments and sub-segments in XML document 107 and writing the corresponding record in the flat file. For each segment and sub-segment, framework 102 requests extraction of the sub-segment by StAX parser 104, and StAX parser 104 returns the XML segment for the specified segment or sub-segment. Each sub-segment may relate to a particular entity, such as an employee or the like.

Additional details are shown in FIG. 4B. Framework 102 requests 422B an XMLBeans object, for example by passing the extracted XML and segment name to translation layer 106. Translation layer 106 generates 422C a corresponding XMLBeans object and returns 422D the XMLBeans object to framework 102. Framework 102 extracts 422E data from the XMLBeans object for generation of a flat file, for example by running Xpath queries configured at the segment level.

Framework 102 extracts XML sub-segments of the current segment one-by-one by passing the name of each sub-segment to StAX parser 104. For each sub-segment, framework 102 requests 424 extraction of the sub-segment by StAX parser 104, and StAX parser 104 returns 425 the XML segment for the specified sub-segment. Framework 102 requests 425A an XMLBeans object, for example by passing the extracted XML and sub-segment name to translation layer 106. Translation layer 106 generates 425B a corresponding XMLBeans object and returns 425C the XMLBeans object to framework 102. Framework 102 extracts 425D data from the XMLBeans object for generation of a flat file, for example by running Xpath queries configured at the sub-segment level. Framework 102 can also use global data extracted earlier and/or application-provided data to assemble the record.

Framework 102 then assembles 425E a body record using the data collected from multiple sources, and writes 429 the record to data store 108 as a flat file.

Steps 421 through 429 can be repeated as many times as needed until every record has been written. In one embodiment, framework 102 loops through the various body segments in the file. Each body segment may contain any number of sub-segments, and framework 102 loops through those as well.

Once all segments are done, framework 102 assembles 429A a footer record, and writes 429B the footer record to data store 108, appending it to the flat file. Framework 102 then closes 429C the file.

Thus, for each body segment, framework 102 can perform the following steps:
Extract the body's start element and its attributes (extractStartElementAndItsAttributes(segmentName).
Append an end tag (appendEndTagInExtractedXml( )).
Request conversion to XMLBeans object (by sending getXmlObject(extractedXml, segmentName) to translation layer 106, which runs createCorrespondingXmlObject( ) and returns the XMLBeans object)
Extract data from the XMLBeans object (runXPathQueriesOnXmlObject( ))

Then, for each sub-segment in the body segment, framework 102 can perform the following steps:
Extract the XML corresponding to the sub-segment.
Request conversion to XMLBeans object (by sending getXmlObject(extractedXml, subSegmentName) to translation layer 106, which runs createCorrespondingXmlObject( ) and returns the XMLBeans object.
Extract data from the XMLBeans object (runXPathQueriesOnXmlObject( )).
Write the extracted data to the flat file (writeExtractedDataInFile( )).

Once all sub-segments in all body segments have been processed, framework 102 writes the footer (writeFooterDataInFile( )) and closes the file (closeFile( )).

In one embodiment, it may be useful for framework 102 to keep track of global data such as the total number of records processed. Such information may be used, for example, for inclusion in a footer or other data element of the flat file being written. In such a situation, application 101 can issue a call, such as addSessionData(key, data), to framework 102. Data included in the call can then be stored and used by framework 102 as appropriate. Examples of such calls include:
addSessionData(“regID”, 36590);
addSessionData(“timeProcessed”, “Jul. 25, 2009”)

Framework 102 can then use the application-supplied session data while writing records in the flat file. In one embodiment, the session data will only be written to a record (body, header, and/or footer) if framework 102 is configured to do so.

### Framework Architecture

The above-described techniques can be implemented using various arrangements of software modules. The following is an example of an architecture for framework 102 that provides a wide variety of configuration options. In one embodiment, a set of producer and translator classes are configured in a configuration file accessible to configurator 103. As described above, application 101 passes the name of the key of the translator class to be used. Framework 102 then performs the requisite task, using translation layer 106 and the specified configuration file. In one embodiment, at least three classes are provided: a producer class for generating XML documents 107, a consumer class for processing XML documents 107 to generate application domain objects usable by application 101, and a transformer class for transforming XML document 107 to another format such as a flat file format. The following are some examples of details of these classes.

### Producer Class

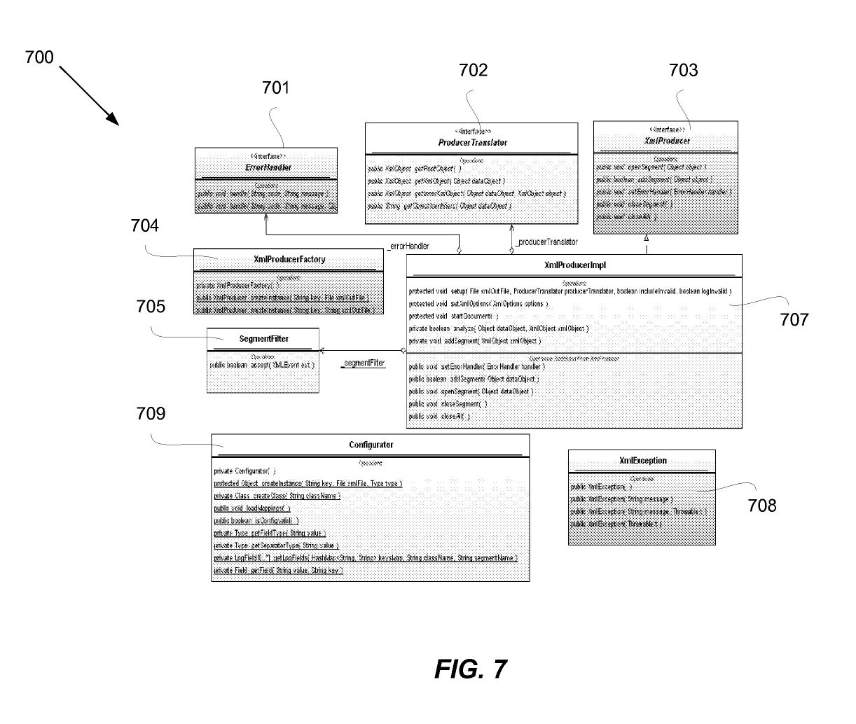

Referring now to FIG. 7, there is shown a class diagram for a producer class 700 according to one embodiment. In this architecture, ErrorHandler 701, XmlProducer 703, XmlProducerFactory 704, and XmlException 708 are exposed to application 101.

Configurator class 709 implements configurator 103, which is responsible for loading, parsing, validating, and caching the configuration provided in the configuration file. Configurator 103 instantiates an instance of XmlProducerImpl, sets configuration parameters, and injects an instance of translator class (as configured). XmlProducerFactory 704 delegates the creation of XmlProducerImpl to the Configurator class 709. In one embodiment, framework 102 uses the following configuration to generate an XML:

classes.keys=<list-of-translator-keys>
<translator-key>.class=<fully-qualified-translator-class>
<translator-key>.includeInvalid=<true|false>
<translator-key>.logInvalid=<true|false>

classes.keys entries are used to specify name of all keys being used in the configuration file. These are the keys for translator classes and all other classes needed to produce, consume, and/or transform and XML file to a flat file. In one embodiment, each XML type (driven by XSD) has a unique key and a unique configuration. The same key is used by application 101 to get an instance of XmlProducer 703.
<translator-key>.class entry specifies the fully qualified (with package name) name of the translator class implementing the ProducerTranslator 702 interface. Application 101 passes the key name to get a reference to XmlProducer 703 instance.
<translator-key>.includeInvalid entry is used by framework 102 to decide whether or not XML segments that fail XSD validation should be included in the result set. It is an optional entry with default value of true.
<translator-key>.logInvalid entry is used by framework 102 to decide whether or not XML segments which fail XSD validation should be logged and/or passed to error handler. It is an optional entry with default value of true.

XmlProducer interface 703 includes operations required to produce an XML document 107. Application 101 uses XmlProducer interface 703 to generate XML segments incrementally. Application 101 passes application data objects; XmlProducer interface 703 produces the XML with the help of translator and XML object classes. In one embodiment, XmlProducer interface 703 includes the following methods:
void openSegment(Object object): Application 101 uses this method to open an XML element so that children of it can be added incrementally. ProducerTranslator interface 702 is implemented by translation layer 106, which uses the passed-in application data object to create an equivalent XMLBeans object.
boolean addSegment(Object object): Application 101 uses this method to add an XML segment into the XML being produced. ProducerTranslator 702 uses the passed-in object to create equivalent XMLBeans object. In one embodiment, the XML segment will be appended as a child element of the last open segment, if any. Otherwise, it will be added as a child of the document root. The return value is true if the segment passes XSD validation; otherwise it is false. In one embodiment, XSD validation is performed only if framework 102 is either configured to exclude invalid segments or configured to log invalid segments.
void setErrorHandler(ErrorHandler handler): Application 101 can, optionally, set an error handler which implements an ErrorHandler interface. XSD validation errors are delegated to the handler, and application 101 can use them in any way. Validation errors are logged using a Java logger if no error handler is set.
void closeSegment( ): Application 101 uses this method to inform framework 102 that incremental addition of all children of currently open segment is over. Framework 102 inserts the ending tag of the last opened segment.
void closeAll( ): Application 101 uses this method to inform framework 102 that it does not have any more data and XML generation is complete. Application 101 calls this method so that the XML can be generated correctly. Framework 102 performs the following operations as a result of this call:
   Closes all open segments by inserting corresponding ending elements into the XML. This feature is useful when application 101 has opened multiple nested segments and wants to close all of them.
   Flushes the buffer and closes the output file.
XmlProducerFactory class 704 encapsulates the creation of objects implementing the XmlProducer interface. In one embodiment, this class includes two overloaded methods for creating objects—one with file object and other with file name for writing the generated XML.

XmlException class 708 is used for exceptions. Framework 102 converts exceptions encountered to an instance of XmlException class 708. This exception wraps the original exception so that no information in the original exception is lost.

ProducerTranslator interface 702 defines the contract between framework 102 and producer translator classes in translation layer 106. Translator classes provide mapping of application data object to equivalent XMLBeans object. In one embodiment, ProducerTranslator interface 702 includes the following methods:
XmlObject getRootObject( ): The translator class should return the root document XmlObject instance so that framework 102 can start generating the root document together with all applicable namespaces.
XmlObject getXmlObject(Object dataObject): The translator class should generate the corresponding XMLBeans instance based on the passed application data object. The generated XMLBeans object (XmlObject) is used by the framework to generate a corresponding segment of XML.
XmlObject getInnerXmlObject(Object dataObject, XmlObject object): The translator class has the knowledge of application data object as well as the corresponding XmlObject. Depending on the way data types are defined in the XSD, while generating the XMLBeans object from the data object, a parent XMLBeans object may be generated in the XML object graph. For example, to generate an XMLBeans object of a single employee record, the Employees XmlObject is first instantiated, followed by an array of size one containing Employee XmlObject. This array is added into the wrapper object. Essentially, it is the Employees XmlObject wrapping the Employee XmlObject. To perform an XSD validation on the employee XmlObject, framework 102 extracts the employee XmlObject from the wrapper XmlObject Employees. The translator class returns the inner XmlObject which corresponds to the application data object. The returned XmlObject is used by the framework to perform the XSD validation.
String getObjectIdentifiers(Object dataObject): XSD validation error messages can vary from parser to parser. It can be very difficult for non-technical people to understand them. These error messages may not provide enough information to identify the record which failed XSD validation. In one embodiment, framework 102 uses getObjectIdentifiers to append additional info in XSD error messages. In one embodiment, it is the translator class that determines the information to be appended. The application data object is passed back to the translation class so that it can extract the appropriate information. The extracted information is appended into XSD validation error messages. The application data object is passed to the translator class as it is the source of information to generate corresponding XML segment. Framework 102 makes use of this function when configured to log XSD validation errors.

XmlProducerImpl class 707 implements the interface XmlProducer. A new instance of this class is returned to application 101 via XmlProducerFactory. Application 101 operates on the XmlProducer instance to produce XML incrementally by invoking methods provided in the XmlProducer interface contract. In one embodiment, all coordination among StAX parser 104, generated XMLBeans objects, translation layer 106, and validation message handling is controlled by XmlProducerImpl class 707. It contains all the functionality needed to produce XML incrementally such as:
Producing XML segments and open segments corresponding to provided application data objects.
Writing XML segments into a file.
Keeping track of all open segments and their ordering.
Running XSD validations on XML segments and delegating validation error messages to an application-specific error handler.

In addition to implementing the interface methods, XmlProducerImpl class 707 can also include internal methods such as:
protected void setup(File xmlOutFile, ProducerTranslator producerTranslator, boolean includeInvalid, boolean logInvalid): Configurator class 709 creates a new instance of this class when application 101 requests an instance of XmlProducer via XmlProducerFactory. Configurator 103 then creates an instance of the translator class as configured and invokes this method to pass configuration information (for example, whether XSD validation needs to be performed, whether to log XSD validation errors, and the translator class instance).
private void startDocument( ): This method is responsible for generating the root document node based on the corresponding XmlObject returned by the translator method getRootObject( ). XML is extracted from the XmlObject and passed to StAX parser 104. The root document end element is pushed into a FIFO (First-In-First-Out) queue. The element is popped and appended into the generated XML once application 101 is done adding all segments and open segments.
private boolean analyze(Object dataObject, XmlObject xmlObject): Framework 102 uses this method to perform XSD validation and to log any XSD errors if configured to do so. It first asks the translator class to provide the inner XmlObject and performs the XSD validation on the returned inner object. It then calls the getObjectIdentifiers(dataObject) method on translator class to get the additional information to be appended to the XSD validation error messages. Finally, the error message is handed over to an application-provided implementation of ErrorHandler for further processing.

SegmentFilter class 705 implements a javax.xml.stream.events.EventFilter interface to filter out start and end document elements from the XML segments generated from non-root XMLObject. It is used by XmlProducerImpl 707 to filter these elements while parsing the XML using StAX parser 104.

### Consumer Class

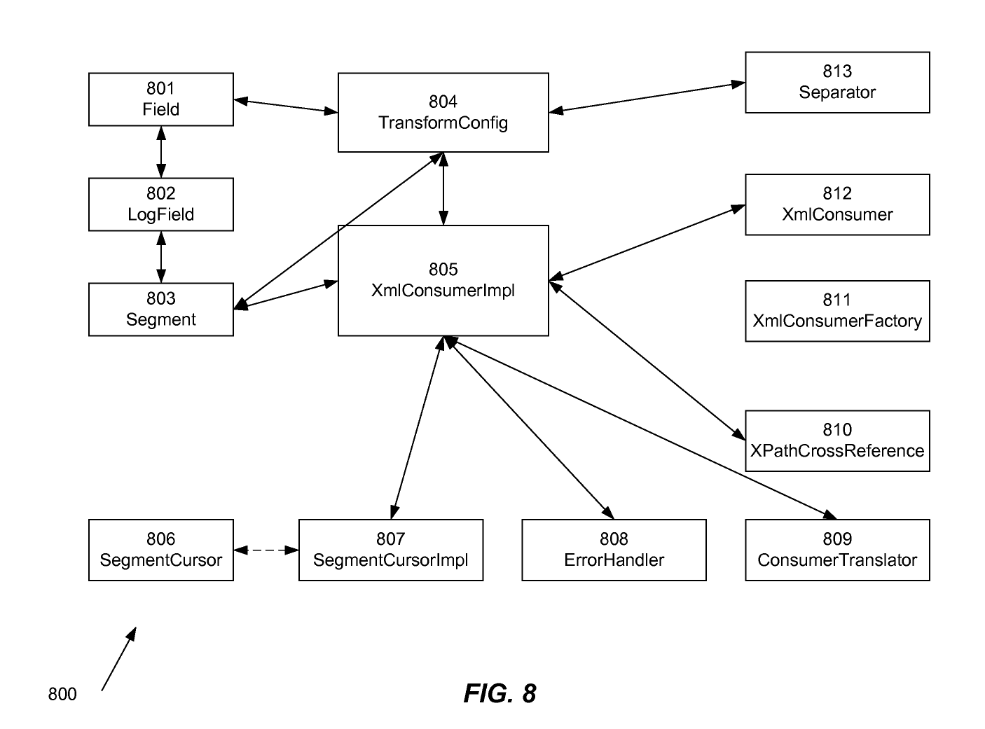

Referring now to FIG. 8, there is shown a class diagram for a consumer class 800 according to one embodiment. In this architecture, XmlConsumer 812, XmlConsumerFactory 811, and SegmentCursor 806 are exposed to application 101.

In one embodiment, consumer class 800 handles two tasks: application data objects generation and XML-to-flat file transformation. Configuration parameters can be used for providing flexible transformation from XML to flat files. In one embodiment, configurator 103 and XmlException 708 classes are common to both consumer class 800 and producer class 700 of framework 102. However, configurator 103 can provide additional configuration parameters for consumer class 800. In addition to the configuration described above in connection with producer class 700, the following additional configuration parameters can be configured for consumer class 800:
Segments and Sub-Segments configuration
   <translator-key>.segments=<ordered-list-of-segments>: Lists all the segments in the XML in the order in which they appear in the XML document. They essentially represent the immediate distinct children of the document root element.
   <translator-key>.segments.<segment-1>=<sub-segments-list>: In one embodiment, this entry is required only when children of configured segments (sub-segments) need to be processed sequentially. They represent unique children of a segment whose sub-segments need to be extracted and processed sequentially. In other words, application 101 may extract them sequentially.
   <translator-key>.segments.<segment-2>=<sub-segments-list>
Cross Reference Configuration: In one embodiment, consumer class 800 keeps data in memory for only one segment/sub-segment at a time. In some cases, data from other segment(s) may be needed. Framework 102 provides a way to store some data contained in a segment/sub-segment for the entire life-cycle of the XML document being processed. Such data is referred to as cross-reference data. The cross-reference data can be configured using XPaths on segments and sub-segments. This data is given an identity via an identifier. The same identifier can be used to refer to the extracted data throughout the life cycle of the XML processing. The following are examples of configurations that can be used to configure the cross references:
   <translator-key>.xpaths.xref.names=<list-of-identifiers>
   <translator-key>.xpaths.xref.<Identifier-1>=<xpath-for-Identifier-1>
   <translator-key>.xapths.xref.<Identifier-2>=<xpath-for-Identifier-2>
XSD Validation Errors Customization configuration: The following configuration can be used to extract additional information to be appended to XSD validation error messages for a particular segment:
   <translator-key>.logs.segment.<segment-name>.names=thst-of-identifiers>
   <translator-key>.logs.segment.<segment-name>.<identifier-1>.displayName=<name-to-beappended-in-error-message>
   <translator-key>.logs.segment.<segment-name>.<identifier-1>.ref=<xpath|cross-ref-identifier>
   <translator-key>.logs.segment.<segment-name>.<identifier-1>.type=<SEGMENT_XPATH|OPEN_SEGMENT_XPATH|X_REF|COUNT|VALUE|SESSION_DATA>

In one embodiment, any number of record identifiers can be associated with a segment. Values of configured identifiers are evaluated based on the associated type field. All of them are evaluated based on the identifier field. The evaluated value and the name specified in the displayName entry are used to generate name-value pairs to be appended to XSD validation error message. For example, to append the employee ID with every invalid employee segment with display name as EMPLOYEE, the configuration might appear as follows:
<translator-key>.logs.segment.employee.names=employeeId
<translator-key>.logs.segment.employee.employeeId.displayName=EMPLOYEE
<translator-key>.logs.segment.employee.employeeId.ref=employee/@id
<translator-key>.logs.segment.employee.employeeId.type=SEGMENT_XPATH

Every XSD validation error message of segment employee would be appended with
EMPLOYEE=<value of XPath query employee/@id>

This additional information assists help in identifying the employee record for which XSD validation failed.

In one embodiment, the following types are supported for record identifier configurations:
SEGMENT_XPATH: The ref field corresponding to this type should be an XPath. The XPath query is evaluated by treating the segment as root document.
OPEN_SEGMENT_XPATH: The ref field corresponding to this type should be an XPath. The XPath query is evaluated by treating the open segment as root document without any of its child elements.
X_REF: The ref field corresponding to this type should be a cross-reference identifier.
VALUE: The ref field value for this type is used as a value without performing any evaluation.
COUNT: The current count of specified segment records is evaluated as value of ref field.
SESSION_DATA: The matching session data with key specified in the ref field is used.

The following are descriptions of the various classes depicted in FIG. 8:

XmlConsumer class 812 is used for abstracting operations required to process an XML document 107. Application 101 uses it to process XML segment s/sub-segments sequentially. Application 101 passes the name of a segment/sub-segment, and framework 102 generates the corresponding application data objects using the corresponding XML segment extracted by StAX parser 104, translation layer 106, and XMLBeans objects. In one embodiment, XmlConsumer class 812 includes the following methods:
SegmentCursor openDataObject(String segmentName): Application 101 uses this method to obtain a cursor to sub-segments of the specified segment. The SegmentCursor interface provides methods to retrieve application data objects corresponding to the segment and all of its sub-segments.
Object getDataObject(String segmentName): Application 101 uses this method to retrieve an application data object corresponding to the specified segment. Framework 102 extracts the specified XML segment using StAX parser 104. The extracted XML and the segment name are passed to the translator class. The translator class instantiates the corresponding XmlObject instance using the segment name and extracted XML segment. Framework 102 performs the XSD validation on the XmlObject generated by the translator class (if configured). Record identifiers are extracted from the XmlObject as configured and appended to the XSD validation errors. Validation errors are handed over to the application-specific error handlers (if provided) for further processing. Finally, framework 102 passes the XmlObject and segment name to the translator class. The translator class generates the corresponding application data object which is returned to application 101.
void setErrorHandler(ErrorHandler handler): Application 101 can, optionally, set an error handler which implements the ErrorHandler interface. XSD validation errors are delegated to the application-specific error handler for further processing.
void doTransform(File transformedFile): Application 101 uses this method to transform the XML file into a flat file. The transformation is driven by the configuration specified in the configuration file.
void addSessionData(String key, Object value): Application 101 uses this method to add application-specific data which is used by the framework to either enrich the transformed file or add additional info in XSD validation errors.

XmlConsumerFactory class 811 is a factory class that encapsulates the creation of objects implementing the XmlConsumer interface. In one embodiment, this class includes two overloaded methods for creating objects—one with a file object and other with a file name of the XML document to be processed.

ConsumerTranslator interface 809 abstracts the operations provided by the consumer translator class. The implementation class has enough knowledge to instantiate an appropriate XmlObject instance from extracted XML segment. Later in the process, corresponding application data objects are instantiated from XmlObject instances. In one embodiment, ConsumerTranslator interface 809 includes the following methods:
XmlObject getRooNodeName( ): The translator class returns the name of the root document node. Framework 102 uses it to identify the root node in the XML being processed.
XmlObject getXmlObject(String segmentName, String segmentXml, String namespaceStartWrapper, boolean is SubSegment): The translator class generates the corresponding XmlObject instance based on the passed segment name and segment XML. The translator class can make use of other two parameters if they are needed. The generated XmlObject is used by the framework to perform XSD validation and extraction of data using XPath queries.
XmlObject getInnerXmlObject(String segmentName, XmlObject object): The translator class has the knowledge of a segment and its XMLBeans object (XmlObject). While generating the XMLBeans from raw XML data, a parent XMLBeans object is generated in the XMLBeans object graph. The returned XMLBeans object is used by framework 102 to perform XSD validation.
Object generateDataObject(XmlObject xmlObject): The translator class uses the passed-in XMLBeans object (XmlObject) to generate a corresponding application data object. The concrete type of passed-in xmlObject instance is used to determine the application data object type to be generated.

XmlConsumerImpl class 805 implements XmlConsumer interface 812. A new instance of this class is returned to application 101 via XmlConsumerFactory 811. Application 101 operates on an XmlConsumer 812 instance to process XML segments sequentially, invoking methods provided in XmlConsumer 812 and SegmentCursor 806 interfaces contracts. In one embodiment, all coordination among StAX parser 104, generated XMLBeans objects, translation layer 106, and validation message handling is controlled by XmlConsumerImpl class 805. It contains all the functionality needed to process XML sequentially, such as:
Generation of application data object(s) by processing XML segments/sub-segments and open segments.
Keeping track of open segment(s).
Running XSD validations on XML segments and delegating errors to error handler.
Extraction of configured data by running XPath queries on XmlObject instances.
Extraction of cross reference data.
Performing transformations from XML to flat file as configured.

In one embodiment, XmlConsumerImpl class 805 implements two different contracts: providing application data objects and transforming XML into a flat file, as described below.

Data Object Extraction. Application data objects are created from the extracted XML segment of the requested segment. In one embodiment, the following steps are followed in order to accomplish this task:
1. Extract the segment/sub-segment based on the segment/sub-segment name passed by application 101.
2. The translator class generates a specific XmlObject instance corresponding to the extracted XML segment.
3. Extract configured XPath cross-reference data by running XPath queries on the returned XmlObject.
4. Perform validation on the returned XmlObject and customize the validation errors (if configured), then hand over errors to an application-specific ErrorHandler 808 for further processing. Additional data (if configured in log entries) is extracted using XPath queries on XmlObject to add extracted data values in error messages.
5. Ignore the current segment if the segment does not pass the XSD validation and skip invalid option is true. Retrieve the next segment and pass it through step (2).
6. The translator class uses XmlObject to generate corresponding application data objects.
7. The generated application-specific data object is returned to application 101.

XML->Flat File Transformation. In one embodiment, the following steps are performed in order to transform XML to a flat file:
1. Extract the segment (if configured) required to generate the header of the flat file
2. The translator class generates a specific XmlObject instance corresponding to the extracted XML segment.
3. Extract configured XPath cross references data by running XPath queries on the returned XmlObject.
4. Perform validation on the returned XmlObject and customize the validation errors (if configured), then hand over errors to ErrorHandler 808 for further processing. Additional data (if configured in log entries) is extracted using XPath queries on XmlObject to add extracted data values in validation error messages.
5. Extract data from the returned XmlObject and run XPath queries to retrieve the data and populate it in the flat file.
6. Repeat steps (1) through (5) for all body segments and sub-segments.
7. Append the footer in the flat file (if configured).

In addition to implementing the interface methods, XmlConsumerImpl class 805 can also include internal methods such as:
protected void setup(File xmlOutFile, ConsumerTranslator trans, Segment[ ] segments, XPathCrossReference[ ] xPathCrossRef, boolean includeInvalid, boolean logInvalid): Configurator class 709 creates a new instance of this class when application 101 requests an instance of XmlConsumer via XmlConsumerFactory. An instance of the translator class is then created and invoked this method to pass configuration information (for example, whether XSD validation needs to be performed, whether to log XSD validation errors, and a list of segments and their sub-segments).
private XmlObject getSegmentXmlObject(String segmentName): This method is responsible for extracting the XML segment corresponding to the passed-in segment name. StAX parser 104 is used to extract the XML segment. The translator class creates the corresponding XMLBeans object from the extracted XML.
private XmlObject openSegment(String segmentName): This method is responsible for extracting the XML segment (without any of its child elements) corresponding to the passed-in segment name. Parsing is stopped as soon as a child of the named segment is detected. A well-formed XML is generated by appending the closing tag. Extracted XML (with appended closing tag) is passed to the translator class. The translator class creates the corresponding XMLBeans object from the extracted XML.
private boolean analyze(String segmentName, XmlObject xmlObject): Framework 102 uses this method to perform XSD validation and log any XSD errors if configured to do so. The translator class provides the inner XMLBeans object or the same object depending on the XSD definition. XSD validation is performed on the returned XMLBeans object. Error messages (if any) are customized based on the provided configuration. Finally, the error message is handed over to ErrorHandler 808 for further processing.

SegmentCursorImpl class 807 provides implementation of a SegmentCursor 806 interface to iterate over the sub-segments of an open segment.

XPathCrossReference class 810 encapsulates the configuration data related to XPath cross references and provides setter/getter method to set and get this data.

Field class 801 encapsulates the configured name and type of an identifier; examples include SEGMENT_XPATH, OPEN_SEGMENT_XPATH, X_REF, VALUE, COUNT, SESSION_DATA, and USER_DEFINED. Field class 801 provides setter/getter methods for names and types.

LogField class 802 extends Field class 801 and adds additional variables to hold a display name and related getter/setter methods.

Separator class 813 encapsulates the configuration data related to record and field separators needed while doing XML to flat file transformation.

TransformConfig class 804 encapsulates all configuration data (such as header, body, footer etc.) needed to transform XML into a flat file.

Segment class 803 encapsulates configuration information about a segment such as its name, parent segment (if any), and sub-segments (if any).

### XML to Flat File Transformation Configuration

As discussed above, in one embodiment the flat file generated by framework 102 has three sections: header, body, and footer. In one embodiment, framework 102 provides multiple configuration options for each of these sections, as follows:

### Header

The header contains metadata such as sender information, transaction ID, number of records, and the like. Data can be extracted from any XML segment to be written in the header. An example of syntax for the configuration is as follows:

```
    <translator-key>.transform.header.segment=<segment-name>
    <translator-key>.transform.header.fields=<list-of-(ref:type)-
pair>
```

segment-name is the name of XML segment where the data need to be extracted from by running XPath queries as specified in fields configuration. In one embodiment, the fields configuration is identical to the XSD validation errors customization configuration. However, ref and type are colon-separated and can be configured by comma-separating each pair. The ref part is evaluated based on the configured type. XPaths configured in this section generally evaluate to a simple text or a single attribute value. The evaluated values are populated in the flat file header in the same order as configured here. Values populated in transformed file are separated by a delimiter. The value of delimiter can be configured as discussed below.

### Body

Any number of segments can be configured, using a format similar to that shown above for the header part. In general, all sub-segments of a configured segment are retrieved recursively, and one record is created and appended into the transformed file every time it encounters a specified sub-segment. As noted earlier, the list of segments and their sub-segments is configured in the order in which they appear in the XML document.

<translator-key>.transform.body.segments=<segments-list>
<translator-key>.transform.body.<segment-1>.fields=<list-
of-(ref:type)-pair>
<translator-key>.transform.body.<segment-2>.fields=<list-
of-(ref:type)-pair>

### Footer

The footer configuration provides support to create a summary record and append it into the transformed file at the end. It follows the similar format as described above for the header:

<translator-key>.transform.footer.fields=<list-of-
(ref:type)-pair>

### Field and Record Delimiters

In one embodiment, any delimiters can be specified. The following configuration can be used to specify delimiters in the transformed files:

<translator-key>.transform.fieldSeparator=<expression-to-
be-evaluated>
<translator-
key>.transform.fieldSeparator.type=VALUE|SYSTEM_PROPERTY|SE
SSION_DATA
<translator-key>.transform.lineSeparator=<expression-to-be-
evaluated>
<translator-
key>.transform.lineSeparator.type=VALUE|SYSTEM_PROPERTY|SES
SION_DATA

### EXAMPLE

The following is an example of generation (production) and processing (consumption) of an XML document 107 using the techniques of the present invention. For illustrative purposes, the example uses the following XSD:

<xml version=“1.0” encoding=“UTF-8” standalone=“yes”>
<xs:schema
xmlns:mp=“http://www.walmart.com/2009/XMLSchema/fulfillment/mp”

```
  xmlns:xs=“http://www.w3.org/2001/XMLSchema”
  targetNames-
```

pace=“http://www.walmart.com/2009/XMLSchema/fulfillment/mp”

elementFormDefault=“unqualified”>

<xs:complexType name=“availabilityType”>

<xs:attribute name=“code” use=“required” type=“xs:string”/>
<xs:attribute name=“quantity” use=“required” type=“xs:int”/>

</xs:complexType>
<xs:complexType name=“itemType”>

<xs:sequence>

<xs:element name=“availability”
type=“mp:availabilityType”/>

</xs:sequence>
<xs:attribute name=“itemId” use=“required” type=“xs:long”/>

</xs:complexType>
<xs:complexType name=“promotionType”>

<xs:attribute name=“code” use=“required” type=“xs:string”/>
<xs:attribute name=“description” use=“optional”

type=“xs:string”/>

</xs:complexType>
<xs:complexType name=“promotionsType”>

<xs:sequence>

<xs:element name=“promotion”
type=“mp:promotionType” maxOc-

curs=“unbounded”/>

</xs:sequence>

</xs:complexType>
<xs:complexType name=“inventoryType”>

<xs:sequence>

<xs:element name=“item” type=“mp:itemType” maxOc-

curs=“unbounded”/>

</xs:sequence>

</xs:complexType>
<xs:element name=“wmi”>

<xs:complexType>

<xs:sequence>

<xs:element name=“transactionInfo”>

<xs:complexType>

<xs:sequence>

<xs:element name=“from”>

<xs:complexType>

<xs:attribute name=“id”
use=“required”

type=“xs:long”/>

<xs:attribute name=“name”
use=“required”

type=“xs:string”/>

</xs:complexType>

</xs:element>

</xs:sequence>
<xs:attribute name=“transactionId”
use=“required”

type=“xs:long”/>

<xs:attribute name=“transactionDate”
use=“required”

type=“xs:date”/>

</xs:complexType>

</xs:element>
<xs:element name=“inventory”
type=“mp:inventoryType” minOc-

curs=“0”/>

<xs:element name=“promotions”
type=“mp:promotionsType” mi-

nOccurs=“0”/>

</xs:sequence>

</xs:complexType>

</xs:element>

</xs:schema>

The following is a sample XML document 107 conforming to the above XSD:

<xml version=“1.0” encoding=“UTF-8”>
<mp:wmi
xmlns:mp=“http://www.walmart.com/2008/XMLSchema/fulfillment/mp”>

<transactionInfo transactionId=“7348891” transactionDate=“2009-01-

22”>

<from id=“255045” name=“Home Partner”/>

</transactionInfo>
<inventory>

<item itemId=“3918290”>

<availability code=“AA” quantity=“200”/>

</item>
<item itemId=“6561233”>

<availability code=“AC” quantity=“50”/>

</item>

</inventory>
<promotions>

<promotion code=“HOLIDAY” description=“Holiday Special”/>
<promotion code=“SIZZLING” description=“Summer
Special”/>

</promotions>

</mp:wmi>

The following example demonstrates producer, consumer, and file transformation operations for the above XSD and the sample XML.

The first step is to generate XMLBeans classes. The following command is used to generate XMLBeans classes:
scomp −d classes −src src sample.xsd

This command generates Java interface classes extending the XMLBeans. Following is a list of sample interface Java classes generated by this process:

AvailabilityType.java
ItemType.java
PromotionsType.java
PromotionType.java
InventoryType.java
WmiDocument.java

Translation layer 106 needs application data objects to operate upon. They are used to generate XML by the producer translator. The consumer translator creates their instances from the extracted XML. Data objects are not aware of any XML events or XMLBeans objects. However, they need to provide ways to extract data from them when being used by producer translator and provide ways to populate data when being used by consumer translators. For illustrative purposes, we assume that application 101 has following three classes to encapsulate the data represented in the sample XML:
HeaderDto, which encapsulates the header level data such as transaction Id, transaction date and information about the sender of the XML document;
InventoryDto, which encapsulates inventory information of an item; and
PromotionDto, which encapsulates the promotion data.

Examples of these classes are shown below.

### Class HeaderDto

public class HeaderDto{

private long _transactionId;
private Calendar _transactionDate;
private long _senderId;
private String _senderName;
public HeaderDto( ){ }
public HeaderDto(long transactionId, Calendar transactionDate,

long senderId, String senderName){

_transactionId = _transactionId;
_transactionDate = _transactionDate;
_senderId = senderId;
_senderName = senderName;

}
public long getTransactionId( ) {return _transactionId;}
public void setTransactionId(long id) {_transactionId = id;}
public Calendar getTransactionDate( ) {return _transactionDate;}
public void setTransactionDate(Calendar date){ _transactionDate =

date;

}
public long getSenderId( ) {return _senderId;}
public void setSenderId(long id) {_senderId = id;}
public String getSenderName( ){return _senderName;}
public void setSenderName(String name) {_senderName = name;}
public String toString( ){

StringBuffer sb = new StringBuffer( );
sb.append(this.getClass( ).getName( ) + “ :

[_transactionId=”+_transactionId);

sb.append(“, _transactionDate=”+_transactionDate);
sb.append(“, _senderId=”+_senderId);
sb.append(“, _senderName=”+_senderName);
sb.append(“]”);
return sb.toString( );

}

}

### Class InventoryDto

public class InventoryDto{

private long _itemId;
private String _code;
private int _quantity;
public InventoryDto( ){
}
public InventoryDto(long itemId, String code, int quantity){

_itemId = itemId;
_code = code;
_quantity = quantity;

}
public long getItemId( ) {return _itemId;}
public void setItemId(long id) {_itemId = id;}
public int getQuantity( ) {return _quantity;}
public void setQuantity(long quantity) {_quantity = quantity;}
public String getCode( ) {return _code;}
public void setCode(String code) {_code = code;}
public String toString( ){

StringBuffer sb = new StringBuffer( );
sb.append(this.getClass( ).getName( ) + “ :
[_itemId=”+_itemId);
sb.append(“, _code=”+_code);
sb.append(“, _quantity=”+_quantity);
sb.append(“]”);
return sb.toString( );

}

}

### Class PromotionDto

public class PromotionDto{

private String _code;
private String _detail;
public PromotionDto( ){
}
public PromotionDto(String code, String detail){

_code = code;
_detail = detail;

}
public String getDetail( ) { return _detail; }
public void setDetail(String detail) {_detail = detail;}
public String getCode( ) {return _code;}
public void setCode(String code) {_code = code;}
public String toString( ){

StringBuffer sb = new StringBuffer( );
sb.append(this.getClass( ).getName( ) + “ : [_code=”+_code);
sb.append (“, _detail=”+_detail);
sb.append(“]”);
return sb.toString( );

}

}

As discussed earlier, producer translator classes implement the ProducerTranslator interface and consumer translator classes implement the ConsumerTranslator interface.

### Producer Translator

In one embodiment, framework 102 can generate XML document 107 in any of three different ways:
Generate the entire XML document 107 at the same time. This approach is feasible when there are not too many inventory and promotion elements. Application 101 provides application data objects which have all the data needed to produce the entire XML document 107. However, in one embodiment, the XmlConsumer interface contract allows passing of only a single object. In this case, the data is encapsulated into multiple data objects—HeaderDto, InventoryDto[ ], and PromotionDto[ ]instances. This can be done in one of two ways: either wrap all the objects in another object, or put all of them in a HashMap. For illustrative purposes, the HashMap approach will be used in this example.
Generate XML document 107 incrementally by adding segments transactionInfo, inventory, and promotions in the given order. Application 101 passes Header, Inventory[ ], and Promotion[ ] instances sequentially to framework 102 so that each segment can be added into the XML.
Generate XML segment transactionInfo, and then open segment inventory and add its sub-segments item sequentially. Similarly generate open segment promotions and add sub-segments promotion sequentially. Application 101 passes HeaderDto instances so that transactionInfo XML segment can be generated. Open segment inventory follows the transactionInfo segment and instances of InventoryDto objects are passed to framework 102 sequentially. The same process (as in case of inventory) is repeated for promotions.

Producer translator class is capable of handling each of these cases; accordingly, it is able to instantiate corresponding XML objects in all three cases.

The properties file is configured to use this translator class, for example by adding the following entries:

classes.keys=invTestProducer
invTestProducer.class=InventoryProducerTranslator
invTestProducer.includeInvalid=false
invTestProducer.logInvalid=true

To generate the entire XML document 107 at the same time, application 101 provides the data (in the form of DTOs) needed to generate the XML document 107. The translator class is implemented in such a way that it can understand what application 101 is trying to accomplish. For example, application 101 may pass a HashMap containing instances of application data objects HeaderDto, InventoryDto[ ] array, and Promotion[ ] array with keys header, inventory, and promotions respectively. Once this parameter is received, framework 102 can generate the entire XML document 107. An example of XML document 107 generated by the is approach is as follows:

<xml version=“1.0” encoding=“UTF-8”>
<mp:wmi
xmlns:mp=“http://www.walmart.com/2009/XMLSchema/fulfillment/mp”>

<transactionInfo transactionId=“789569” transactionDate=“2009-03-

26”>

<from id=“7348891” name=“Home Partner”></from>

</transactionInfo>
<inventory>

<item itemId=“3918290”>

<availability quantity=“200” code=“AA”></availability>

</item>
<item itemId=“6561233”>

<availability quantity=“50” code=“AC”></availability>

</item>

</inventory>
<promotions>

<promotion description=“Holiday Special”

code=“HOLIDAY”></promotion>

<promotion description=“Summer Special”

code=“SIZZLING”></promotion>

</promotions>

</mp:wmi>

To generate XML document 107 incrementally, transactionInfo, inventory, and promotions segments are added sequentially. For example, framework 102 generates the transactionInfo XML segment from HeaderDto, inventory segment from InventoryDto[ ]array, and promotions from PromotionDto[ ]array instances.

To generate XML document 107 by adding segments and sub-segments sequentially, a transactionInfo segment is added first, followed by an inventory sub-segments item, and promotions sub-segments promotion sequentially. Framework 102 first generates the transactionInfo XML segment from HeaderDto instance. Next, it adds an open segment for inventory and adds all its sub-segments sequentially. After closing the inventory segment, the open segment promotions is added. All of its sub-segments are later added sequentially. A call to closeAll( ) closes all open segments in the order in which they were opened.

### Consumer Translator

In one embodiment, framework 102 can process XML document 107 in any of three different ways:
Extract segments (such as transactionInfo, inventory, and promotions) sequentially. Application 101 can retrieve them sequentially. All sub-segments of these segments will be retrieved together with the respective segment.
Extract segment transactionInfo, and then open segment inventory followed by sequential extraction of its sub-segments (item). Finally, open segment promotions followed by sequential extraction of its sub-segments (promotion).
Transform XML document 107 to a flat file as specified in the configuration file.

Consumer translator class is used for handling any of these cases.

The properties file is configured to use this translator class, for example by adding the following entries:

invTestConsumer.class=InventoryConsumerTranslator
invTestConsumer.includeInvalid=false
invTestConsumer.logInvalid=true
invTestConsu-
mer.segments=transactionInfo,inventory,promotions
invTestConsumer.segments.inventory=item
invTestConsumer.segments.promotions=promotion

These entries instruct framework 102 as follows:
Use InventoryConsumerTranslator class for translation.
Do not include the segments/sub-segments which fail the XSD validation.
Do log the XSD validation errors.
There are three children of the root node—transactionInfo, inventory, and promotions; these are referred to as segments.
item is the only sub-segment (child node) of inventory segment.
promotion is the only sub-segment (child node) of promotions segment.

As discussed above, framework 102 can process XML document 107 by extracting segments (transactionInfo, inventory, and promotions) sequentially if desired. An example of output generated by such processing is as follows:

HeaderDto : [_transactionId=789569, _transactionDate=2009-03-26,
_senderId=7348891, _senderName=Home Partner]
InventoryDto : [_itemId=3918290, _code=AA, _quantity=200]
InventoryDto : [_itemId=6561233, _code=AC, _quantity=50]
PromotionDto : [_code=HOLIDAY, _detail=Holiday Special]
PromotionDto : [_code=SIZZLING, _detail=Summer Special]

Promotion and item sub-segments can be processed sequentially. Processing sub-segments sequentially can be useful when a large number of sub-segments are expected, and extracting all of them together may cause application 101 to run out of memory.

First, framework 102 processes the fixed-size segment transactionInfo. After processing the transactionInfo segment, application 101 asks framework 102 to open the inventory segment and process item sub-segments sequentially. Finally, application 101 asks framework 102 to open the segment promotions and processes the sub-segments promotion sequentially.

When translating XML document 107 to a flat file, the transformed data has two different sources: XML- and application-specified. XML data to be extracted is expressed using XPaths; application-specified data is expressed as session data. In one embodiment, data is configured appropriately for each section of the flat file to be written: header, body, and footer. For example, suppose the header is to include the following fields, all coming from the transactionInfo segment:
transactionId
sender Id
sender Name

Suppose the body of the flat file is to include fields from the inventory and promotions segments. Fields corresponding to a sub-segment will constitute a body record in the transformed file. Sender Id and transaction Id from the transactionInfo segment will be included via cross references. Also, each inventory record should start with word INVENTORY and promotion record with word PROMOTION. Furthermore, suppose the cumulative record count and application specified field—processing date are also to be added. The following fields constitute an inventory/promotion and footer record in the flat file:
Inventory Segment
   INVENTORY word as is
   sender Id from transactionInfo segment
   item id
   availability code
   availability quantity
   application data—processing date
   transaction id from transactionInfo segment
   Cumulative item record count within inventory segment
Promotions Segment
   PROMOTION word as is
   sender Id from transactionInfo segment
   promotion code
   transaction id from transactionInfo segment
   Cumulative promotion record count within promotions segment
Footer
   transaction id from transactionInfo segment
   Number of item records
   Number of promotion records
   Total number of promotion and item records.

The following is an example of configuration to include above fields in the transformed file:

invTestConsu-
mer.xpaths.xref.names=transactionId,senderId,senderName
invTest Consu-
mer.xpaths.xref.transactionId=transactionInfo/@transactionId
invTestConsumer.xpaths.xref.senderId=transactionInfo/from/@id
invTestConsumer.xpaths.xref.senderName=transactionInfo/from/@name
invTestConsumer.transform.header.segment=transactionInfo
invTestConsu-
mer.transform.header.fields=transactionId:X_REF,transactionInfo/f
rom/@id:SEGMENT_XPATH,senderName:X_REF
invTestConsumer.transform.body.segments=inventory,promotions
invTestConsu-
mer.transform.body.fields.inventory=INVENTORY:VALUE,senderId:X_RE
F,inventory/item/@itemId:SEGMENT_XPATH,inventory/item/availabilit
y/@code:SEGMENT_XPATH,inventory/item/availability/@quantity:SEGME
NT_XPATH,processingDate:SESSION_DATA,transactionId:X_REF,item:COU
NT
invTestConsu-
mer.transform.body.fields.promotions=PROMOTION:VALUE,senderId:X_R
EF,promotions/promotion/@code:SEGMENT_XPATH,transactionId:X_REF,p
romotion:COUNT
invTestConsu-
mer.transform.footer.fields=transactionId:X_REF,item:COUNT,promot
ion:COUNT,item+promotion:COUNT

Fields that are being cross-referenced from one segment to another are included in the list of cross reference config.

An example of the resultant flat file is as follows:

789569|7348891|Home Partner
INVENTORY|7348891|3918290|AA|200|Thu Mar 26 11:55:31 PDT
2009|789569|1
INVENTORY|7348891|6561233|AC|50|Thu Mar 26 11:55:31 PDT
2009|789569|2
PROMOTION|7348891|HOLIDAY|789569|1
PROMOTION|7348891|SIZZLING|789569|2
789569|2|2|4

In this example, framework 102 uses the output of toString( ) function of all application added data. Default record separator (new line) and default field separator (|) are used as they were not specified.

In one embodiment, XSD validation error message can be customized by appending additional information in them. For example, suppose we wish to add transactionId(via cross reference) and itemId whenever an item sub-segment fails XSD validation. The display name for transactionId should be TRANSACTION ID and Item # for itemId. Configuration entries for this customization might be as follows:

invTestConsumer.logs.segment.item.names=transactionId,item_Id
invTestConsu-
mer.logs.segment.item.transactionId.displayName=TRANSACTION
invTestConsumer.logs.segment.item.transactionId.ref=transactionId
invTestConsumer.logs.segment.item.transactionId.type=X_REF
invTestConsumer.logs.segment.item.item_Id.displayName=Item
invTestConsu-
mer.logs.segment.item.item_Id.ref=inventory/item/@itemId
invTestConsumer.logs.segment.item.item_Id.type=SEGMENT_XPATH

An error message would then read as follows:

Invalid decimal value: unexpected char ‘88’ [TRANSACTION ID =

789569, Item # = 3918290]

Information within the square brackets has been added by framework 102 (as configured) for inclusion when an invalid item segment is encountered.

### CONCLUSION

Based on the above description it can be seen that, in various embodiments, the system of the present invention provides several advantages over prior art schemes. The system of the present invention combines the streaming and flexibility of a StAX parser with the power and ease of use of XMLBeans, so that XML documents of arbitrary size can be processed and/or generated serially. In addition, application code can be insulated from the details of parsing and processing XML documents, making the application code easier to maintain and facilitating swap-out with other XML technology without impacting the application.

In various embodiments, the present invention can be implemented as a system or a method for performing the above-described techniques, either singly or in any combination. In another embodiment, the present invention can be implemented as a computer program product comprising a nontransitory computer-readable storage medium and computer program code, encoded on the medium, for causing a processor in a computing device or other electronic device to perform the above-described techniques.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared, transformed, and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware or hardware, and when embodied in software, can be down-loaded to reside on and be operated from different platforms used by a variety of operating systems.

The present invention also relates to an apparatus for performing the operations herein. This apparatus may be specially constructed for the required purposes, or it may comprise one or more general-purpose computer(s) selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers and/or other electronic devices referred to in the specification may include a single processor or may be architectures employing multiple processor designs for increased computing capability. In one embodiment, some or all of the functional components described above are implemented as computer hardware including processors performing the above-described steps under the control of software.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

Accordingly, in various embodiments, the present invention can be implemented as software, hardware, or other elements for controlling a computer system, computing device, or other electronic device, or client/server architecture, or any combination or plurality thereof. Hardware for implementing the system of the present invention can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the invention (or components of the invention) include: a mobile phone, personal digital assistant, smartphone, kiosk, desktop computer, laptop computer, consumer electronic device, television, set-top box, or the like. An electronic device for implementing the present invention may use an operating system such as, for example, Microsoft Windows 7 available from Microsoft Corporation of Redmond, Wash., or any other operating system that is adapted for use on the device.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

While the invention has been particularly shown and described with reference to a preferred embodiment and several alternate embodiments, it will be understood by persons skilled in the relevant art that various changes in form and details can be made therein without departing from the spirit and scope of the invention.

1. A computer-implemented method for processing an XML document, comprising:
in a processor, receiving a message from an application requesting data from the XML document;
in a processor, responsive to receiving the message:
retrieving, from the XML document, at least one segment representing the requested data;
converting the retrieved at least one segment to an object-based XML representation; and
transforming the object-based XML representation to at least one application data object; and
in a processor, transmitting the at least one application data object to the application.

2. The method of claim 1, wherein:
transforming the object-based XML representation to at least one application data object comprises translating at least one XML data object to at least one application-domain object; and
transmitting the extracted at least one application data object to the application comprises transmitting the translated application-domain object to the application.

3. The method of claim 1, wherein the object-based representation comprises an object in an XML-binding framework.

4. The method of claim 1, wherein the object-based representation comprises an XMLBeans object.

5. The method of claim 1, wherein retrieving at least one segment representing the requested data comprises:
sending a request to a parser to retrieve the at least one segment; and
receiving the segment from the parser.

6. The method of claim 5, wherein the parser comprises a StAX parser.

7. The method of claim 1, further comprising:
in a processor, validating the object-based representation.

8. The method of claim 7, wherein validating the object-based representation comprises:
in a processor, performing validation on the object-based representation against an XML schema definition.

9. The method of claim 1, wherein retrieving, from the XML document, at least one segment representing the requested data comprises:
in a processor, retrieving at least one segment; and
in a processor, recursively retrieving at least one sub-segment of the retrieved segment.

10. The method of claim 1, wherein retrieving, from the XML document, at least one segment representing the requested data comprises:
in a processor, requesting a location of the at least one segment of the XML document from a configuration;
in a processor, receiving the requested location; and
in a processor, retrieving data from the requested location.

11. The method of claim 10, wherein retrieving data from the requested location comprises:
in a processor, calling a parser to parse the XML document to retrieve the data.

12. The method of claim 1, wherein retrieving, from the XML document, at least one segment representing the requested data comprises:
in a processor, instantiating a segment cursor to keep track of a location within the XML document; and
in a processor, retrieving data at a location corresponding to the segment cursor.

13-25. (canceled)

26. A computer program product for processing an XML document, comprising:
a non-transitory computer-readable storage medium; and
computer program code, encoded on the medium, configured to cause at least one processor to perform the steps of:
receiving a message from an application requesting data from the XML document;
responsive to receiving the message:
retrieving, from the XML document, at least one segment representing the requested data;
converting the retrieved at least one segment to an object-based XML representation; and
transforming the object-based XML representation to at least one application data object; and
transmitting the at least one application data object to the application.

27-29. (canceled)

30. A system for processing an XML document, comprising:
in a computing system having a processor, a framework for receiving a message from an application requesting data from the XML document and for requesting extraction of an XML segment;
a parser, communicatively coupled to the framework, configured to provide, to the framework, at least one segment representing the requested data; and
a translation layer, communicatively coupled to the framework, configured to perform the steps of:
converting the retrieved at least one segment to an object-based XML representation; and
transforming the object-based XML representation to at least one application data object;
wherein the framework is further configured to transmit the at least one application data object to the application.

31-32. (canceled)

33. The computer program product of claim 26, wherein:
the computer program code configured to cause at least one processor to transform the object-based XML representation to at least one application data object comprises computer program code configured to cause at least one processor to translate at least one XML data object to at least one application-domain object; and
the computer program code configured to cause at least one processor to transmit the extracted at least one application data object to the application comprises computer program code configured to cause at least one processor to transmit the translated application-domain object to the application.

34. The computer program product of claim 26, wherein the object-based representation comprises an object in an XML-binding framework.

35. The computer program product of claim 26, wherein the object-based representation comprises an XMLBeans object.

36. The computer program product of claim 26, wherein the computer program code configured to cause at least one processor to retrieve at least one segment representing the requested data comprises computer program code configured to cause at least one processor to perform the steps of:
sending a request to a parser to retrieve the at least one segment; and
receiving the segment from the parser.

37. The computer program product of claim 36, wherein the parser comprises a StAX parser.

38. The computer program product of claim 26, further comprising:
computer program code configured to cause at least one processor to validate the object-based representation.

39. The computer program product of claim 38, wherein the computer program code configured to cause at least one processor to validate the object-based representation comprises computer program code configured to cause at least one processor to perform validation on the object-based representation against an XML schema definition.

40. The computer program product of claim 26, wherein the computer program code configured to cause at least one processor to retrieve, from the XML document, at least one segment representing the requested data comprises computer program code configured to cause at least one processor to perform the steps of:
retrieving at least one segment; and
recursively retrieving at least one sub-segment of the retrieved segment.

41. The computer program product of claim 26, wherein the computer program code configured to cause at least one processor to retrieve, from the XML document, at least one segment representing the requested data comprises computer program code configured to cause at least one processor to perform the steps of:
requesting a location of the at least one segment of the XML document from a configuration;
receiving the requested location; and
retrieving data from the requested location.

42. The computer program product of claim 41, wherein the computer program code configured to cause at least one processor to retrieve data from the requested location comprises:
the computer program code configured to cause at least one processor to call a parser to parse the XML document to retrieve the data.

43. The computer program product of claim 26, wherein the computer program code configured to cause at least one processor to retrieve, from the XML document, at least one segment representing the requested data comprises the computer program code configured to cause at least one processor to perform the steps of:
instantiating a segment cursor to keep track of a location within the XML document; and
retrieving data at a location corresponding to the segment cursor.

44. The system of claim 30, wherein:
the translation layer is configured to transform the object-based XML representation to at least one application data object by translating at least one XML data object to at least one application-domain object; and
the framework is configured to transmit the extracted at least one application data object to the application by transmitting the translated application-domain object to the application.

45. The system of claim 30, wherein the object-based representation comprises an object in an XML-binding framework.

46. The system of claim 30, wherein the object-based representation comprises an XMLBeans object.

47. The system of claim 30, wherein:
the framework is configured to sending a request to a parser to retrieve the at least one segment representing the requested data; and
the parser is configured to provide the at least one segment responsive to the request from the framework.

48. The system of claim 47, wherein the parser comprises a StAX parser.

49. The system of claim 30, wherein the framework is further configured to validate the object-based representation.

50. The system of claim 49, wherein the framework is further configured to validate the object-based representation by performing validation on the object-based representation against an XML schema definition.

51. The system of claim 30, wherein the parser provides the at least one segment representing the requested data by:
retrieving at least one segment; and
recursively retrieving at least one sub-segment of the retrieved segment.

52. The system of claim 30, wherein the parser provides the at least one segment representing the requested data by:
requesting a location of the at least one segment of the XML document from a configuration;
receiving the requested location; and
retrieving data from the requested location.

53. The system of claim 30, wherein the parser provides the at least one segment representing the requested data by:
instantiating a segment cursor to keep track of a location within the XML document; and
retrieving data at a location corresponding to the segment cursor.
